(19) United States
(12) Patent Application Publication
(10) Pub. No.: US 2026/0303793 A1
(43) Pub. Date: Oct. 1, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/686,498

(22) Filed: May 22, 2026

Related U.S. Application Data
(63) Continuation of application No. PCT/CN2024/133985, filed on Nov. 22, 2024.

(30) Foreign Application Priority Data
Nov. 23, 2023 (WO) PCT/CN2023/133734

(51) Int. Cl. H04N 19/11; H04N 19/105; H04N 19/46

(52) U.S. Cl. CPC H04N 19/11; H04N 19/105; H04N 19/46

(57) ABSTRACT

Embodiments of the disclosure provide a solution for video processing. A method for video processing is proposed. The method includes: deriving, for a conversion between a video unit of a video and a bitstream of the video, a first target coding mode at decoder side based on coding information associated with the video unit, wherein the first target coding mode is a variant of a matrix weighted intra prediction (MIP) mode; and performing the conversion based on the first target coding mode.

### CROSS-REFERENCE TO RELATED APPLICATIONS

This application is a continuation of International Application No. PCT/CN2024/133985, filed on Nov. 22, 2024, which claims the benefit of International Application No. PCT/CN2023/133734, filed on Nov. 23, 2023. The entire contents of these applications are hereby incorporated by reference in their entireties.

### FIELDS

Embodiments of the present disclosure relates generally to video processing techniques, and more particularly, to decoder derived matrix weighted intra prediction (MIP) mode.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, the coding performance of video coding techniques is generally expected to be further improved.

### SUMMARY

Embodiments of the present disclosure provide a solution for video processing.

In a first aspect, a method for video processing is proposed. The method comprises: deriving, for a conversion between a video unit of a video and a bitstream of the video, a first target coding mode at decoder side based on coding information associated with the video unit, wherein the first target coding mode is a variant of a matrix weighted intra prediction (MIP) mode; and performing the conversion based on the first target coding mode. Compared with the conventional solution, the method in accordance with the first aspect of the present disclosure can improve the coding performance by the decoder derived MIP mode.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: deriving a first target coding mode at decoder side based on coding information associated with a video unit of the video, wherein the first target coding mode is a variant of a matrix weighted intra prediction (MIP) mode; and generating the bitstream based on the first target coding mode.

In a fifth aspect, a method for storing a bitstream of a video is proposed. The method comprises: deriving a first target coding mode at decoder side based on coding information associated with a video unit of the video, wherein the first target coding mode is a variant of a matrix weighted intra prediction (MIP) mode; generating the bitstream based on the first target coding mode; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of encoder block diagram;

FIG. 5 illustrates 67 intra prediction modes;

FIG. 6A and FIG. 6B illustrate reference samples for wide-angular intra prediction;

FIG. 7 illustrates problem of discontinuity in case of directions beyond 45°;

FIG. 8 illustrates a matrix weighted intra prediction process;

FIG. 9 illustrates spatial GPM candidates;

FIG. 10 illustrates GPM template;

FIG. 11 illustrates GPM blending;

FIG. 12 shows neighboring reconstructed samples used for DIMD chroma mode;

FIG. 13 illustrates positions of spatial merge candidate;

FIG. 14 illustrates candidate pairs considered for redundancy check of spatial merge candidates;

FIG. 15 illustrates illustration of motion vector scaling for temporal merge candidate;

FIG. 16 illustrates candidate positions for temporal merge candidate, C0 and C1;

FIG. 17 illustrates VVC spatial neighboring blocks of the current block;

FIG. 18 illustrates illustration of virtual block in the i-th search round;

FIG. 19 illustrates examples of the GPM splits grouped by identical angles;

FIG. 20 illustrates uni-prediction MV selection for geometric partitioning mode;

FIG. 21 illustrates exemplified generation of a blending weight w₀ using geometric partitioning mode;

FIG. 22 illustrates spatial neighboring blocks used to derive the spatial merge candidates;

FIG. 23 illustrates template matching performs on a search area around initial MV;

FIG. 24 illustrates SBT position, type and transform type;

FIG. 25A to FIG. 25I illustrates templates for DDMIP, respectively;

FIG. 26 illustrates the derivation of the prediction of the template for DDMIP;

FIG. 27 illustrates a flowchart of a method for video processing in accordance with embodiments of the present disclosure; and

FIG. 28 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

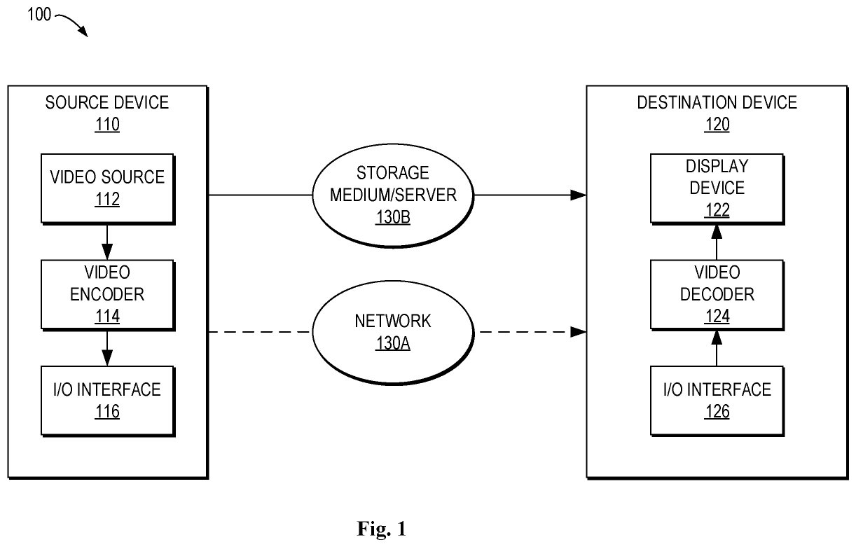

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof. The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

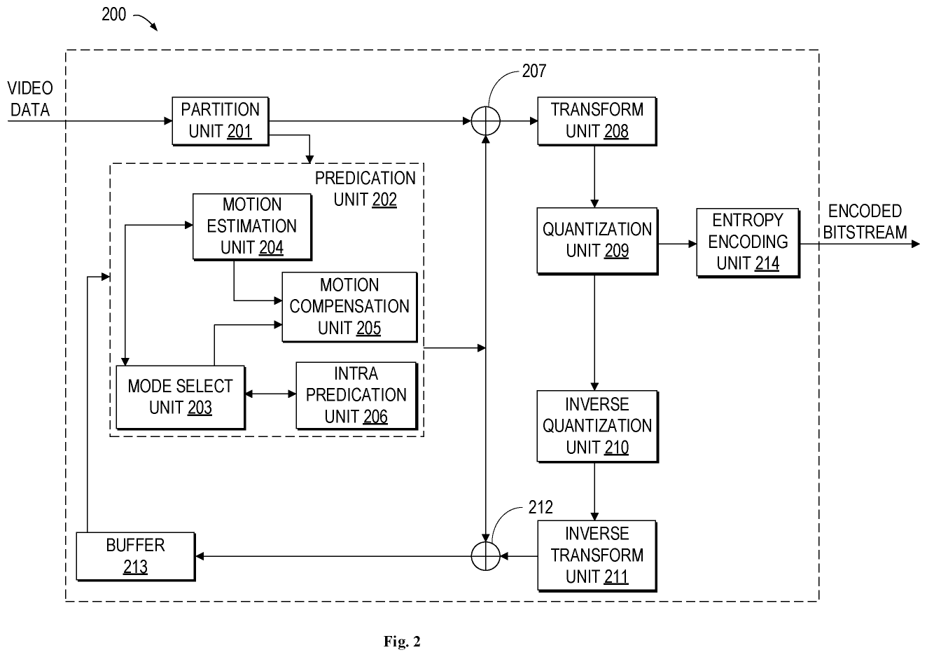

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

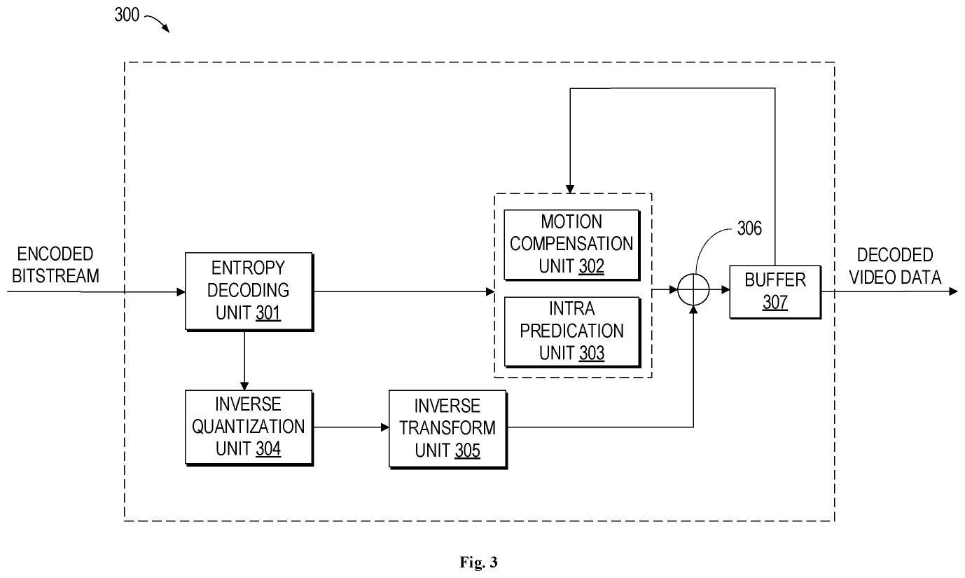

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is related to Matrix weighted intra prediction (MIP), and how to fuse MIP with other coding tools, and other coding tools in image/video coding. It may be applied to the existing video coding standard like HEVC, or Versatile Video Coding (VVC). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTCI SC29/WG11 (MPEG) was created to work on the VVC standard targeting at 50% bitrate reduction compared to HEVC.

### 2.1. Coding Flow of a Typical Video Codec

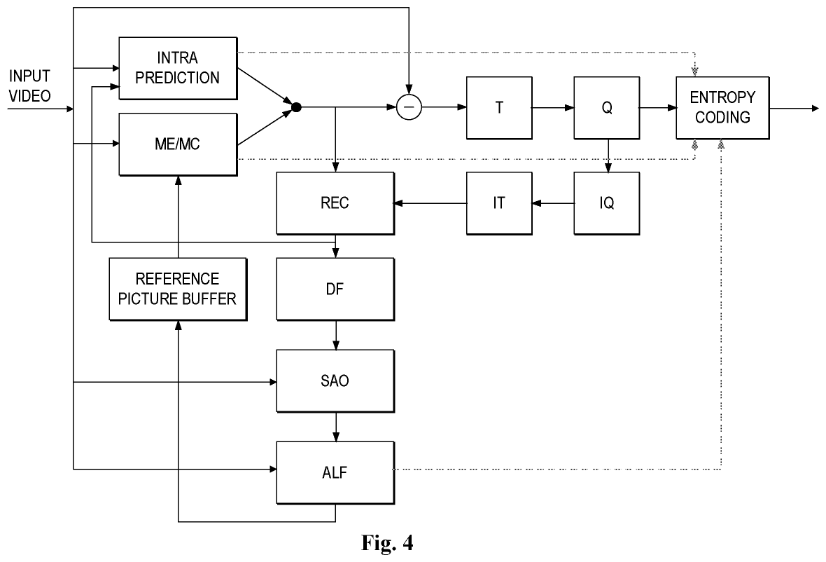

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.2. Intra Mode Coding with 67 Intra Prediction Modes

To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

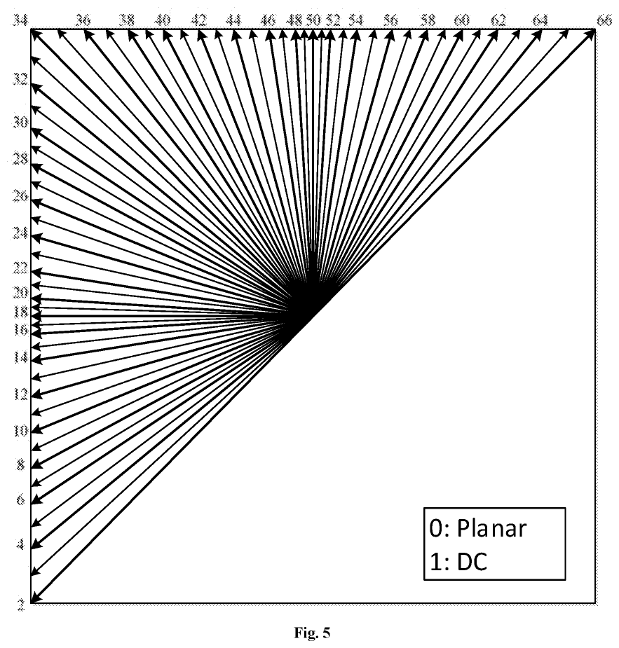

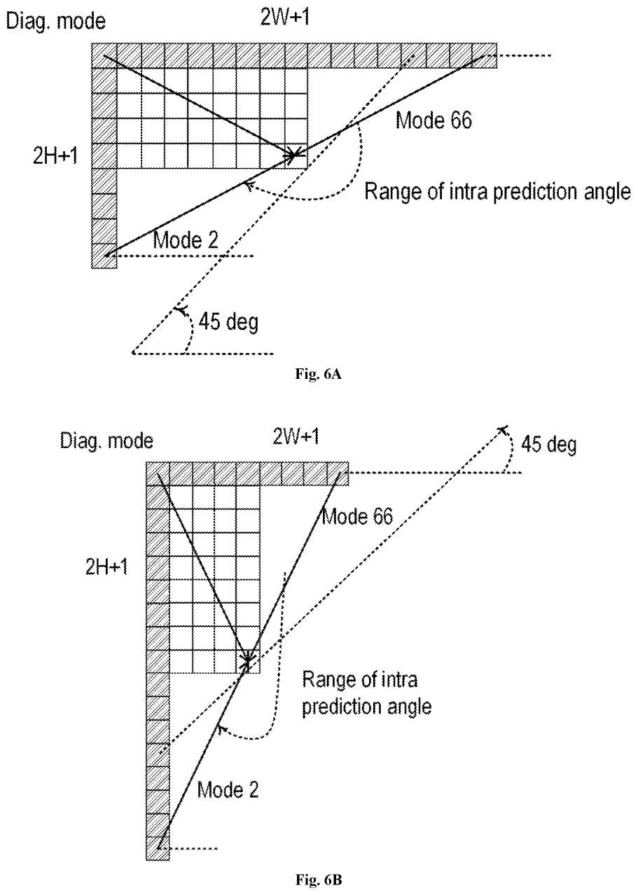

To support these prediction directions, the top reference with length 2W+1, and the left reference with length 2H+1, are defined as shown in FIG. 6A and FIG. 6B, which illustrate reference samples for wide-angular intra prediction.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

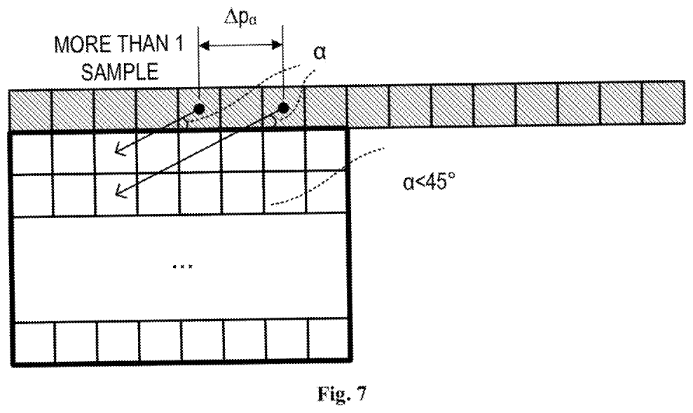

FIG. 7 illustrates problem of discontinuity in case of directions beyond 45°. As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Apa. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5. Matrix Weighted Intra Prediction (MIP)

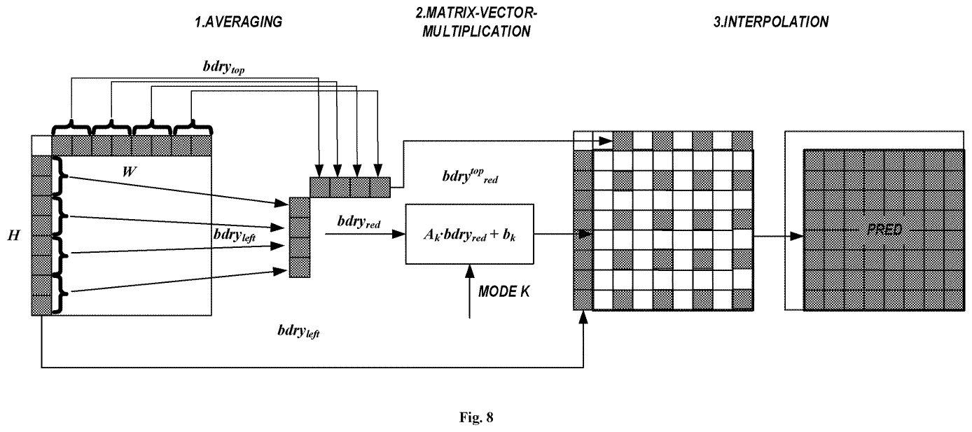

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 8.

### 2.5.1. Averaging Neighbouring Samples

Among the boundary samples, four samples or eight samples are selected by averaging based on block size and shape. Specifically, the input boundaries bdry^{top} and bdry^{left} are reduced to smaller boundaries

$${bdry}_{red}^{top} and {bdry}_{red}^{left}$$

by averaging neighbouring boundary samples according to predefined rule depends on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 1 )$$

### 2.5.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 2 )$$

$${H}_{red} = \{ \begin{matrix}4 & for max ( W , H ) \leq 8 \\ min ( H , 8 ) & for max ( W , H ) > 8\end{matrix} \qquad ( 2 - 3 )$$

The reduced prediction signal pred_{red} is computed by calculating a matrix vector product and adding an offset:

$${pred}_{red} = A \cdot {bdry}_{red} + b . \qquad ( 2 - 4 )$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx (W, H) as follows:

$$idx ( W , H ) = \{ \begin{matrix}0 & for W = H = 4 \\ 1 & for max ( W , H ) = 8 \\ 2 & for max ( W , H ) > 8.\end{matrix} \qquad ( 2 - 5 )$$

Here, each coefficient of the matrix A is represented with 8 bit precision. The set S₀ consists of 16 matrices

$${A}_{0}^{i} ,$$

i∈{0, . . . , 15} which has 16 rows and 4 columns and 16 offset vectors

$${b}_{0}^{i} ,$$

i∈{0, . . . , 16} each of size 16. Matrices and offset vectors of that set are used for blocks of size 4×4. The set S₁ consists of 8 matrices

$${A}_{1}^{i} ,$$

i∈{0, . . . , 7}, each of which has 16 rows and 8 columns and 8 offset vectors

$${b}_{1}^{i} ,$$

i∈{0, . . . , 7} each of size 16. The set S₂ consists of 6 matrices

$${A}_{2}^{i} ,$$

i∈{0, . . . , 5}, each of which has 64 rows and 8 columns and of 6 offset vectors

$${b}_{2}^{i} ,$$

i∈{0, . . . , 5} 01 of size 54.

### 2.5.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

2.5.4. Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows:

$$isTransposed = predModeIntra \& 1 \qquad ( 2 - 6 )$$

$$modeId = predModeIntra ≫ 1$$

MIP coding mode is harmonized with other coding tools by considering following aspects:
LFNST is enabled for MIP on large blocks. Here, the LFNST transforms of planar mode are used.
The reference sample derivation for MIP is performed exactly as for the conventional intra prediction modes.
For the up-sampling step used in the MIP-prediction, original reference samples are used instead of down-sampled ones.
Clipping is performed before up-sampling and not after up-sampling.
MIP is allowed up to 64×64 regardless of the maximum transform size.

The number of MIP modes is 32 for sizeId=0, 16 for sizeId=1 and 12 for sizeId=2.

2.6. Spatial Geometric partitioning mode (SGPM)

SGPM is an intra mode that resembles the inter coding tool of GPM, where the two prediction parts are generated from intra predicted process. In this mode, a candidate list is built with each entry containing one partition split and two intra prediction modes as shown in FIG. 9. 26 partition modes and 3 of intra prediction modes are used to form the combinations, the length of the candidate list is set equal to 16. The selected candidate index is signalled.

The list is reordered using template (FIG. 10) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

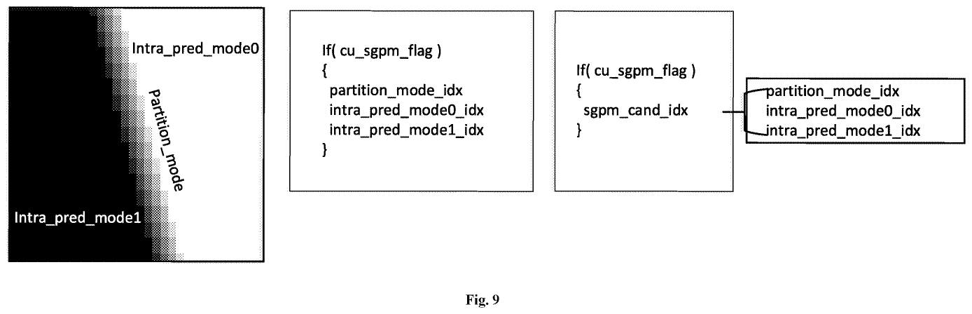

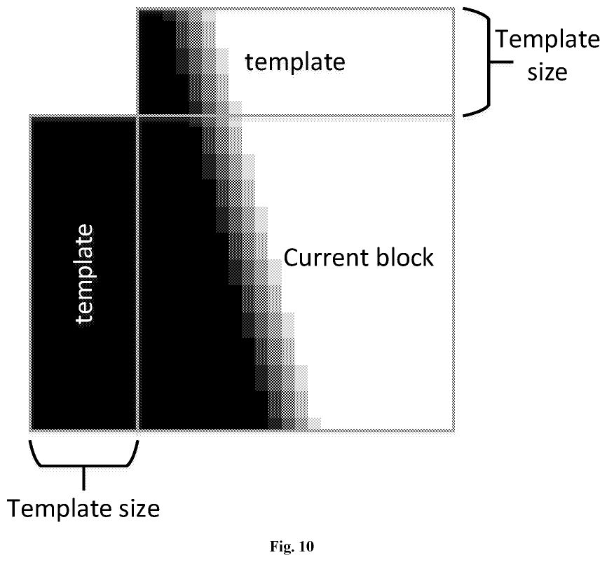

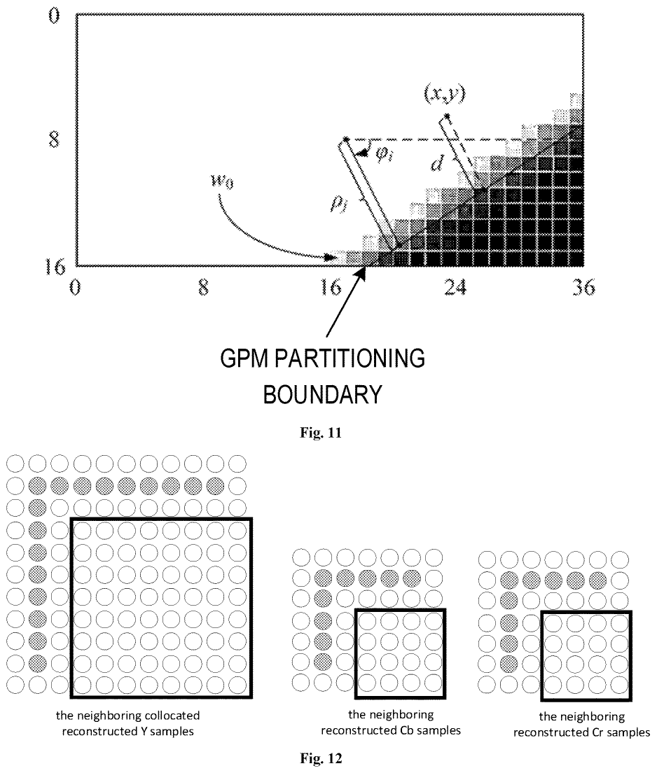

A PPS flag is coded to indicate whether no blending of two intra predictions is allowed. When this PPS flag is set to false, the following adaptive blending is also used for spatial GPM, where blending depth τ shown in FIG. 11 is derived as follows:
If min(width, height)==4, ½ τ is selected
else if min(width, height)==8, τ is selected
else if min(width, height)==16, 2 τ is selected
else if min(width, height)==32, 4 τ is selected
else, 8 τ is selected.

Otherwise (the PPS flag is set to true), ¼ τ is always used for spatial GPM coded blocks to make sure no blending is used when SGPM block has partition angle completely horizontal or vertical, and much narrower blending width is used when SGPM block has other partition angles. It is noted that the flag is set to true in current Common Test Conditions (CTC) for the screen content videos.

### 2.7. Decoder Side Intra Mode Derivation (DIMD)

When DIMD is applied, up to five intra modes are derived from the reconstructed neighbor samples, and those five predictors are combined with the planar mode predictor with the weights derived from the histogram of gradients. The division operations in weight derivation are performed utilizing the same lookup table (LUT) based indigenization scheme used by the CCLM. For example, the division operation in the orientation calculation

$$Orient = {G}_{y} / {G}_{x}$$

is computed by the following LUT-based scheme:

$$x = Floor ( Log 2 ( G x ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) x$$

$$where DivSigTable [ 16 ] = \{ 07 , 6 , 5 , 5 , 4 , 4 , 3 , 3 , 2 , 2 , 1 , 1 , 1 , 1 , 0 \} .$$

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = {wDimd}_{i} + {Δ}_{i} - 2 {Δ}_{i} \frac{y}{( H - 1 )} .$$

If the left histogram is twice the above, then:

$${w}_{i} ( x , y ) = {wDimd}_{i} + {Δ}_{i} - 2 {Δ}_{i} \frac{x}{( W - 1 )} ,$$

where wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, note the region of neighboring reconstructed samples used for computing the histogram of gradients is modified, depending on reconstructed samples availability. The region of decoded reference samples of current WxH luma CB is extended towards the above-right side if available, up to W additional columns. It is extended towards the bottom-left side if available, up to H additional rows.

### 2.7.1. DIMD Chroma Mode

The DIMD chroma mode uses the DIMD derivation method to derive the chroma intra prediction mode of the current block based on the neighboring reconstructed Y, Cb and Cr samples in the second neighboring row and column as shown in FIG. 12 where neighboring reconstructed samples are used for DIDM chroma mode. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

Finally, the luma region of reconstructed samples used for computing the histogram of gradients for chroma DIMD mode is modified. For a WxH pair of chroma CBs to predict, to build the histogram of gradients associated to the collocated luma CB, the pairs of a vertical gradient and a horizontal gradient are extracted from the second and third lines in this luma CB instead of being extracted from the regular set of DIMD decoded reference samples around this luma CB.

### 2.8. Template-Based Intra Mode Derivation (TIMD)

For each intra prediction mode in MPMs, as well as the wide-angle modes if the above-right and/or bottom-left reference samples are available, SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( c ostMode 1 + costMode 2 )$$

$$weight 2 = 1 - weight 1$$

The division operations are conducted using the same lookup table (LUT) based integerization scheme used by the CCLM.

### 2.9. Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

2.10. Extended merge prediction

In VVC, the merge candidate list is constructed by including the following five types of candidates in order:
(1) Spatial MVP from spatial neighbour CUs.
(2) Temporal MVP from collocated CUs.
(3) History-based MVP from a FIFO table.
(4) Pairwise average MVP.
(5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.10.1. Spatial Candidates Derivation

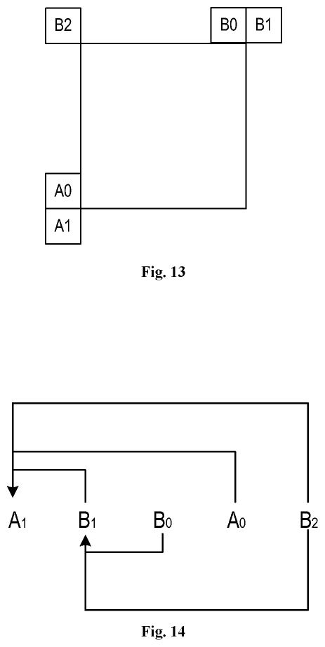

The derivation of spatial merge candidates in VVC is same to that in HEVC except the positions of first two merge candidates are swapped. FIG. 13 illustrates positions of spatial merge candidate. A maximum of four merge candidates are selected among candidates located in the positions depicted in FIG. 13. The order of derivation is B0, A0, B1, A1 and B2. Position B2 is considered only when one or more than one CUs of position B0, A0, B1, A1 are not available (e.g. because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 14 illustrates candidate pairs considered for redundancy check of spatial merge candidates. Instead only the pairs linked with an arrow in FIG. 14 are considered and a candidate is only added to the list if the corresponding candidate used for redundancy check has not the same motion information.

### 2.10.2. Temporal Candidates Derivation

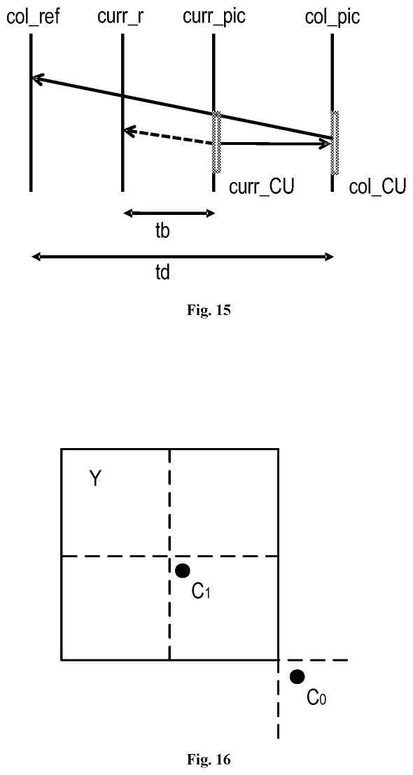

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 15 illustrates illustration of motion vector scaling for temporal merge candidate. The scaled motion vector for temporal merge candidate is obtained as illustrated by the dotted line in FIG. 15, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C0 and C1, as depicted in FIG. 16. If CU at position C0 is not available, is intra coded, or is outside of the current row of CTUs, position Cl is used. Otherwise, position C0 is used in the derivation of the temporal merge candidate.

### 2.10.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:

Number of HMPV candidates is used for merge list generation is set as (N<=4)? M: (8-N), wherein N indicates number of existing candidates in the merge list and M indicates number of available HMVP candidates in the table.

Once the total number of available merge candidates reaches the maximally allowed merge candidates minus 1, the merge candidate list construction process from HMVP is terminated.

### 2.10.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

2.10.5. Merge estimation region

Merge estimation region (MER) allows independent derivation of merge candidate list for the CUS in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

### 2.11. New Merge Candidates

### 2.11.1. Non-Adjacent Merge Candidates Derivation

FIG. 17 illustrates VVC spatial neighboring blocks of the current block. In VVC, five spatially neighboring blocks shown in FIG. 17 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

$$Offsetx = - i \times 2 \times gridX , Offsety = - i \times gridY$$

where the Offsetx and Offsety denote the offset of the top-left corner of the virtual block relative to the top-left corner of the current block, gridX and gridY are the width and height of the search grid.

Second, the width and height of the virtual block are calculated by:

$$newWidth = i \times 2 \times gridX + currWidth$$

$$newHeight = i \times 2 \times gridY + currHeight .$$

where the currWidth and currHeight are the width and height of current block. The newWidth and newHeight are the width and height of new virtual block.
gridX and gridY are currently set to currWidth and currHeight, respectively.

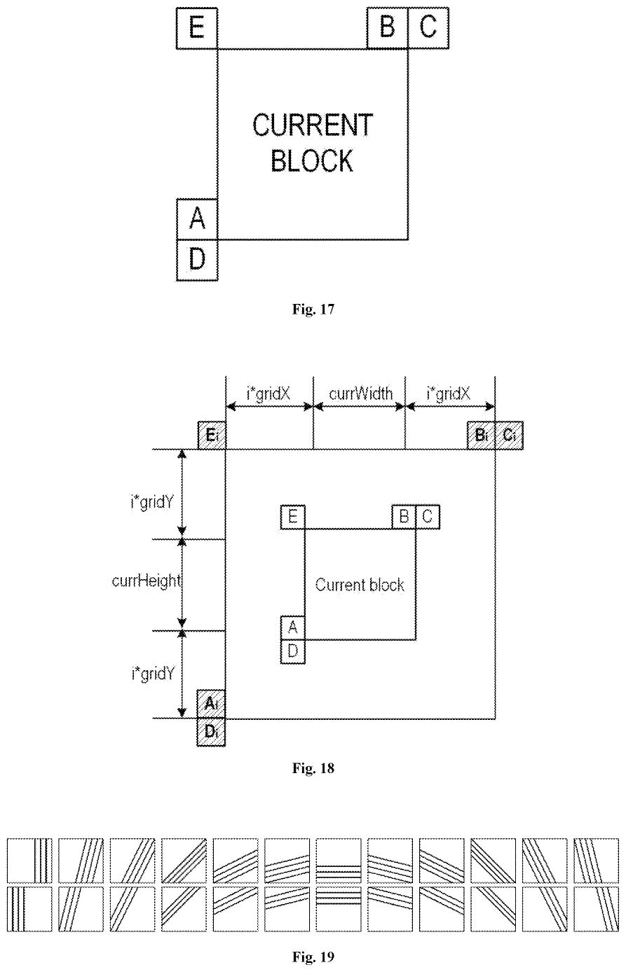

FIG. 18 illustrates the relationship between the virtual block and the current block.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.11.2. STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

$$mvLX = ( mvLX\_F + mvLX\_S + mvLX\_T + mvLX\_Col ) ≫ 2$$

2) If reference indices of three of the four merge candidates are valid and are equal to zero in prediction direction X (X=0 or 1),

$$mvLX = ( mvLX\_F \times 3 + mvLX\_S \times 3 + mvLX\_Col \times 2 ) ≫ 3 or$$

$$mvLX = ( mvLX\_F \times 3 + mvLX\_T \times 3 + mvLX\_Col \times 2 ) ≫ 3 or$$

$$mvLX = ( mvLX\_S \times 3 + mvLX\_T \times 3 + mvLX\_Col \times 2 ) ≫ 3$$

3) If reference indices of two of the four merge candidates are valid and are equal to zero in prediction direction X (X=0 or 1),

$$mvLX = ( mvLX\_F + mvLX\_Col ) ≫ 1 or$$

$$mvLX = ( mvLX\_S + mvLX\_Col ) ≫ 1 or$$

$$mvLX = ( mvLX\_T + mvLX\_Col ) ≫ 1$$

Note: If the temporal candidate is unavailable, the STMVP mode is off.

### 2.11.3. Merge List Size

If considering both non-adjacent and STMVP merge candidates, the size of merge list is signalled in sequence parameter set header and the maximum allowed size of merge list is 8.

### 2.12. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

FIG. 19 illustrates examples of the GPM splits grouped by identical angles. When this mode is used, a CU is split into two parts by a geometrically located straight line (FIG. 19). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in. This is the prediction signal for the whole CU, and transform and quantization process will be applied to the whole CU as in other prediction modes. Finally, the motion field of a CU predicted using the geometric partition modes is stored as in.

### 2.12.1. Uni-Prediction Candidate List Construction

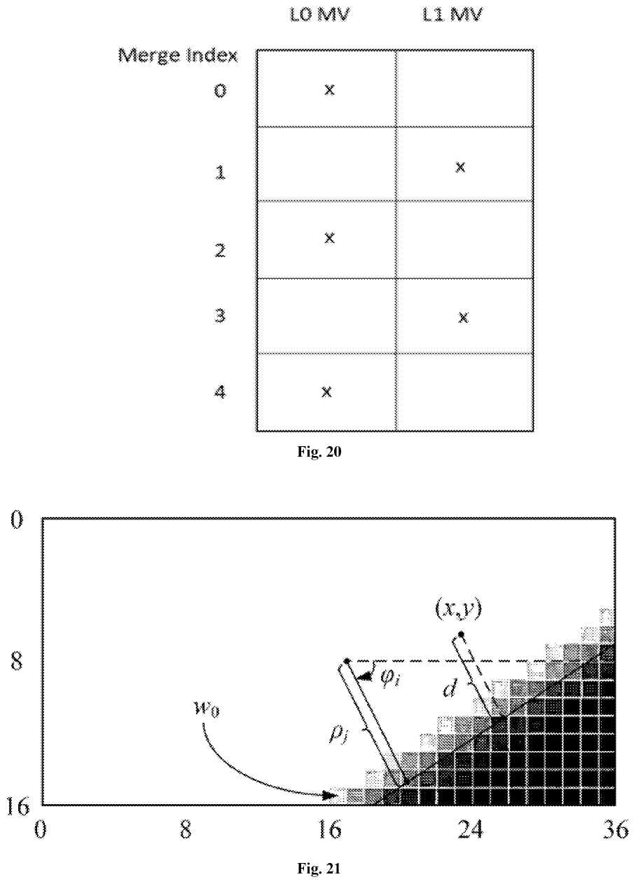

The uni-prediction candidate list is derived directly from the merge candidate list constructed according to the extended merge prediction process in. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. FIG. 20 illustrates uni-prediction MV selection for geometric partitioning mode. These motion vectors are marked with “x” in FIG. 20. In case a corresponding LX motion vector of the n-the extended merge candidate does not exist, the L (1−X) motion vector of the same candidate is used instead as the uni-prediction motion vector for geometric partitioning mode.

### 2.12.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 7 )$$

$${ρ}_{j} = {ρ}_{x , j} cos ( {φ}_{i} ) + {ρ}_{y , j} sin ( {φ}_{i} ) \qquad ( 2 - 8 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 9 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 10 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 11 )$$

$${w}_{0} ( x , y ) = \frac{Clip 3 ( 0 , 8 , ( wIdxL ( x , y ) + 4 ) ≫ 3 )}{8} \qquad ( 2 - 12 )$$

$${w}_{1} ( x , y ) = 1 - {w}_{0} ( x , y ) \qquad ( 2 - 13 )$$

The partIdx depends on the angle index i. One example of weigh w₀ is illustrated in FIG. 21. FIG. 21 illustrates exemplified generation of a blending weight w₀ using geometric partitioning mode.

### 2.12.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 14 )$$

where motionIdx is equal to d(4×+2,4y+2), which is recalculated from equation (2-14). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
   Otherwise, if Mv1 and Mv2 are from the same list, only uni-prediction motion Mv2 is stored.

### 2.13. Non-Adjacent Spatial Candidate

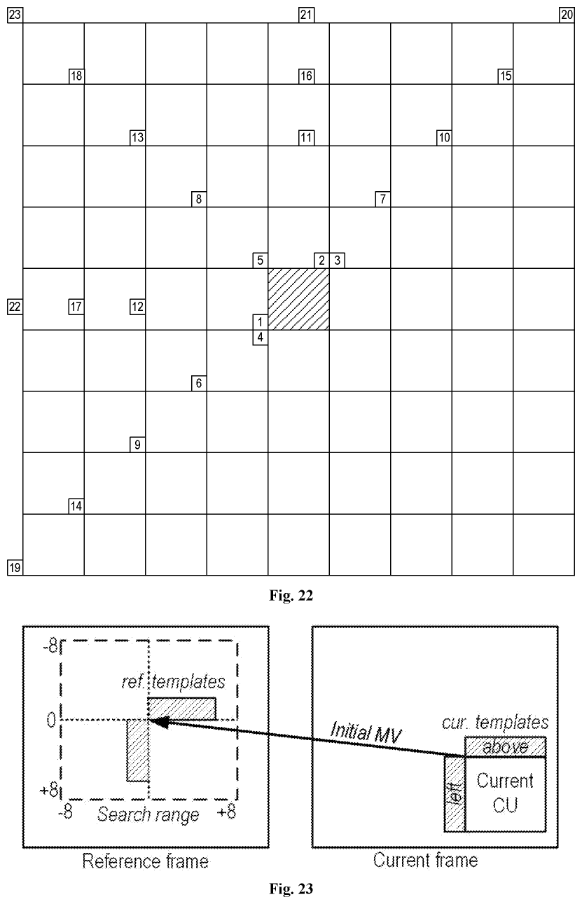

The non-adjacent spatial merge candidates are inserted after the TMVP in the regular merge candidate list. FIG. 22 illustrates spatial neighboring blocks used to derive the spatial merge candidates. The pattern of the spatial merge candidates is shown on FIG. 22. The distances between the non-adjacent spatial candidates and the current coding block are based on the width and height of the current coding block.

### 2.14. Template Matching (TM)

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 23 illustrates template matching performs on a search area around initial MV. As illustrated in FIG. 23, a better MV is to be searched around the initial motion of the current CU within a [−8, +8]-pel search range. The template matching is adopted in this contribution with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 2. This search process ensures that the MVP candidate still keeps the same MV precision as indicated by AMVR mode after TM process.

TABLE 2
Search patterns of AMVR and merge mode with AMVR.

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In merge mode, similar search method is applied to the merge candidate indicated by the merge index. As Table 2 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

2.15. Multiple transform selection (MTS) for core transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 3 shows the basis functions of the selected DST/DCT.

TABLE 3
Transform basis functions of DCT-II/VIII and
DSTVII for N-point input

| Transform Type | Basis function Tᵢ(j), i, j = 0, 1, . . . , N − 2 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 4. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 4
Transform and signalling mapping table

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.16. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

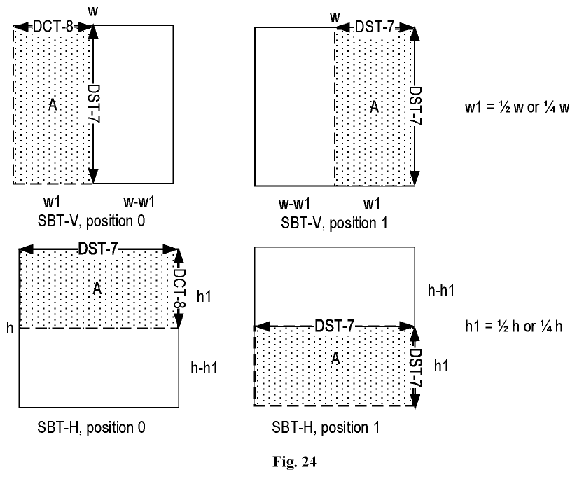

When SBT is used for an inter-coded CU, SBT type and SBT position information are signaled in the bitstream. There are two SBT types and two SBT positions, as indicated in FIG. 24. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 24. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 3. PROBLEMS

In current design of MIP of ECM, the best MIP mode is determined at encoder and needs to be signalled to the decoder. The signalling overhead for the MIP modes may limit the coding performance of MIP. Similar to DIMD/TIMD, the decoder derived MIP mode could reduce the signaling overhead and improve the coding performance.

### 4. DETAILED SOLUTIONS

The detailed solutions below should be considered as examples to explain general concepts. These solutions should not be interpreted in a narrow way. Furthermore, these solutions can be combined in any manner.

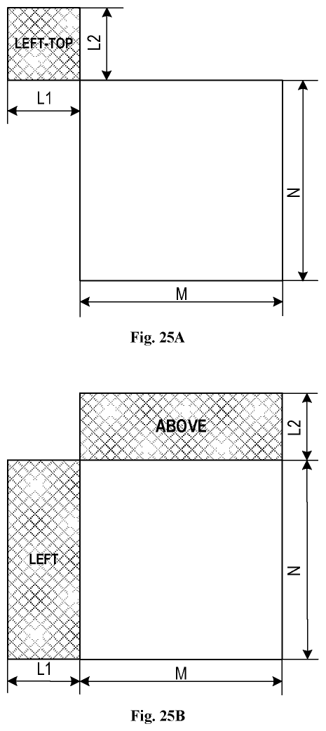

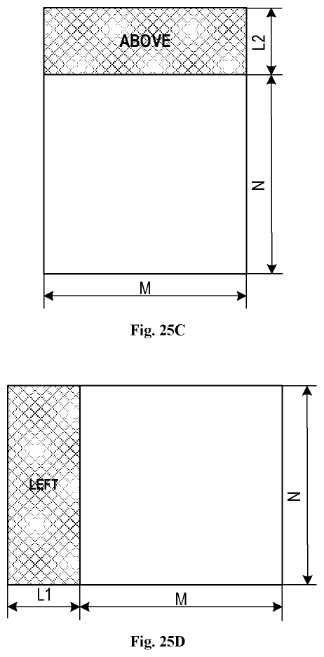

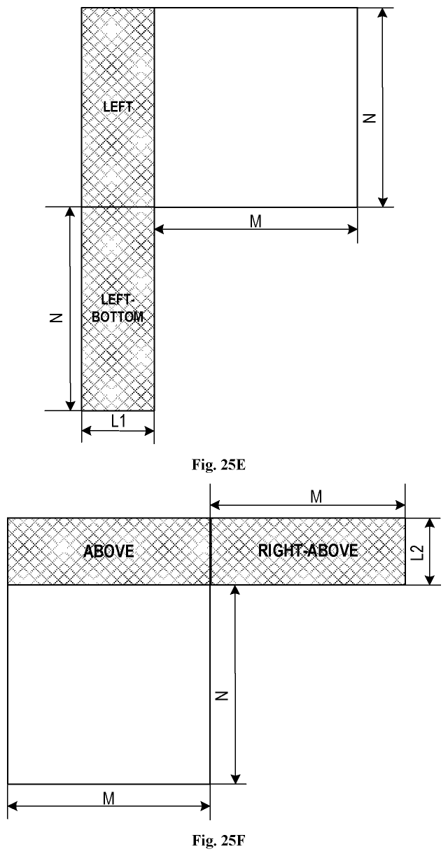

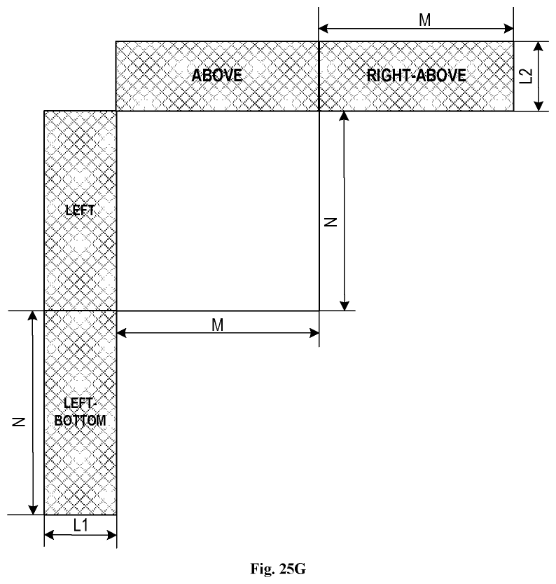

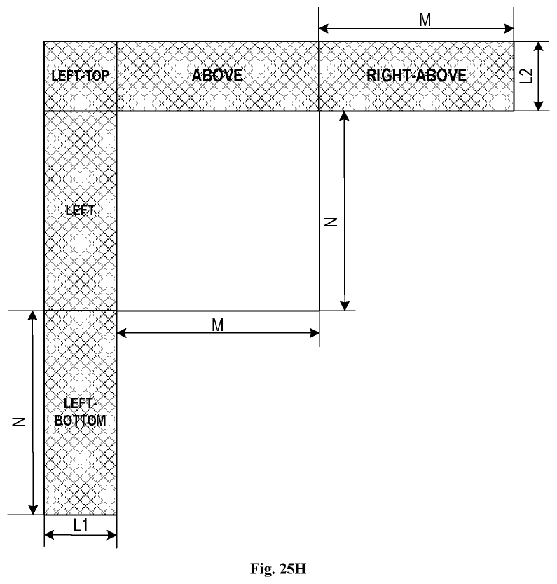

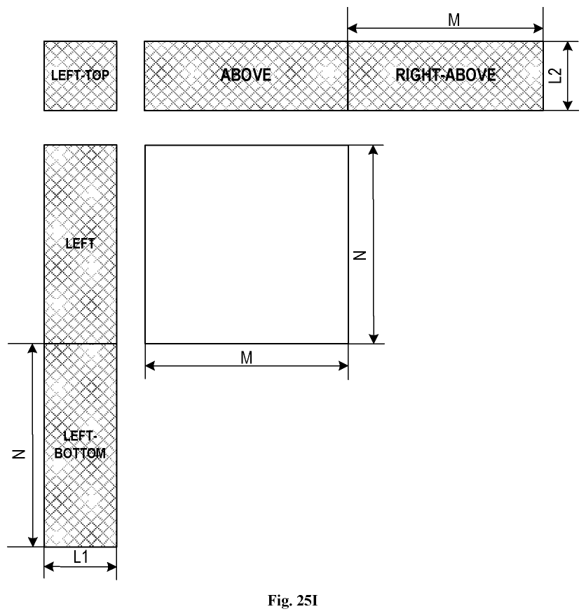

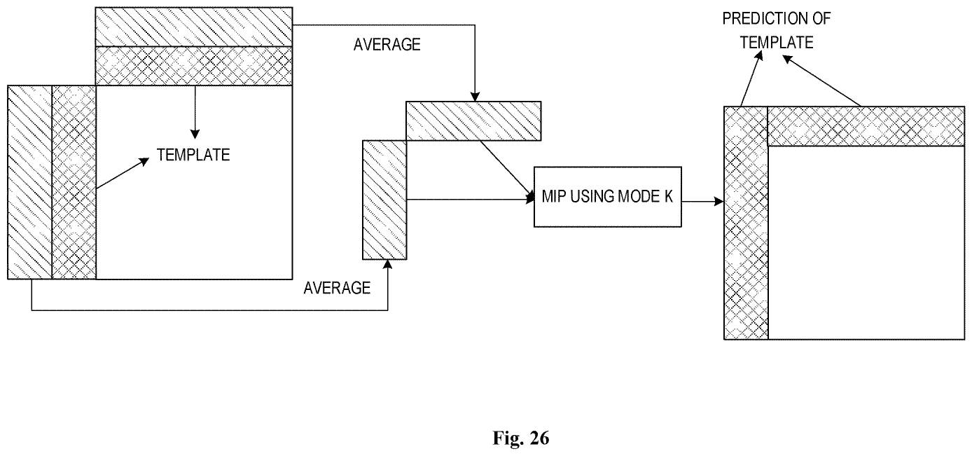

FIG. 25A to FIG. 25I shows templates for DDMIP, respectively.

FIG. 26 shows derivation of the prediction of the template for DDMIP.

### Decoder Derived MIP (DDMIP)

1. It is proposed that the MIP mode may be derived implicitly at decoder side with coding information such as coding mode(s) and reconstructed samples.
   a. In one example, the MIP mode is derived without signaling.
   b. In one example, a flag may be signaled to indicate whether MIP should be signaled explicitly or derived implicitly.
   c. It is proposed to derive MIP mode using the neighbouring samples of the current video unit, and the derived MIP mode may be used to obtain the prediction/reconstruction of the current video unit. Denote the coding mode as DDMIP.
   d. In one example, a template consisting of neighbouring samples of the current video unit may be used to derive the MIP mode.
      i. In one example, the neighbouring samples may be neighbouring reconstructed and/or predicted samples.
      ii. In one example, the neighbouring samples may be adjacent and/or non-adjacent.
      iii. In one example, as shown in FIG. 25H, A template may be from of Template-L, Template-A, Template-RA, Template-LB, and Template-LA, where Template-L is composed of left neighbouring samples, Template-A is composed of above neighbouring samples, Template-RA is composed of right-above neighbouring samples, Template-LB of left-bottom neighbouring samples and Template-LA of left-above neighbouring samples.
         1) In one example, the above templates may be non-adjacent to the current block (e.g., shown in FIG. 25I).
      iv. In one example, only one template is used to derive the MIP mode.
         1) In one example, the template may refer to Template-L, or Template-A, or Template-RA, or Template-LB, or Template-LA shown in FIG. 25H.
         a) In one example, Template-L may be used to derive the MIP mode (e.g., FIG. 25D).
         b) In one example, Template-A may be used to derive the MIP mode (e.g., FIG. 25C).
      v. In one example, multiple templates may be used to derive the MIP mode.
         a) In one example, Template-L+Template-A may be used to derive the MIP mode (e.g., FIG. 25B).
         b) In one example, Template-L+Template-A+Template-LA may be used to derive the MIP mode (e.g., FIG. 25A and FIG. 25B).
         c) In one example, Template-L+Template-LB may be used to derive the MIP mode (e.g., FIG. 25E).
         d) In one example, Template-A+Template-RA may be used to derive the MIP mode (e.g., FIG. 25F).
         e) In one example, Template-L+Template-LB+Template-A+Template-RA may be used to derive the MIP mode (e.g., FIG. 25G).
      vi. In one example, Template-L+Template-LB+Template-A+Template-RA+Template-LA may be used to derive the MIP mode (e.g., FIG. 25H).
      vii. In one example, the dimension/shape/size of the template used to derive the MIP mode may depend on the decoded information of current block (e.g., block dimension, or/and block shape, or/and slice/picture type).
         1) Alternatively, the dimension/size of the template may be a constant value, such as 1/2/3/4/5/6/7/8.
   e. In one example, an MIP mode is used to generate the prediction of the template and a cost is calculated using the prediction and the reconstruction of the template. The MIP mode in an MIP mode list in with the minimum cost is selected as the derived MIP mode.
      i. In one example, the neighbouring samples of the template may be used to obtain the prediction of the template. An example is shown in FIG. 26.
         1) In one example, the way to obtain the prediction of the template may be same as the way to obtain the prediction of the current video unit.
         a) Alternatively, the way to obtain the prediction of the template may be different from the way to obtain the prediction of the current video unit.
         i. In one example, the averaging process may be different.
         ii. In one example, the linear interpolation may be different.
         2) In one example, one or more lines of neighbouring samples of the template may be used.
         3) In one example, the neighbouring samples of the template may be filtered before being used to obtain the prediction of the template.
      ii. In one example, the sum of the absolute transformed difference (SATD) between the predicted samples and the reconstructed samples of the template may be calculated and set as the cost.
         1) Alternatively, the sum of the squared errors (SSE) may be calculated and set as the cost.
         2) Alternatively, the sum of the absolute difference (SAD) may be calculated and set as the cost.
         3) Alternatively, a subjective quality metric may be calculated and set as the cost.
         4) In one example, the structural similarity index measure (SSIM) may be calculated and set as the cost.
         5) The cost may be calculated in a form of D+lambda×R, wherein D is a metric of distortion such as SAD, SATD, SSE et. al, R represents the number of bits under consideration and lambda is a pre-defined factor . . . .
   f. In one example, how to use the derived MIP mode to obtain the prediction for the current video unit may be same as MIP.
2. In one example, an MIP mode list may be constructed and used in the derivation of the MIP mode.
   a. In one example, the number of MIP modes in the MIP mode list may be less than or equal to the number of MIP modes that are allowed to be used for the current video unit, which are signalled in the bitstream for MIP.
      i. Alternatively, the number of MIP modes in the MIP mode list may be larger than the number of MIP modes that are allowed to be used for the current video unit.
   b. In one example, any MIP mode in the MIP mode list must be one of MIP modes that are allowed to be used for the current video unit, which are signalled in the bitstream for MIP.
      i. Alternatively, at least one MIP mode in the MIP mode list may be different from any of MIP modes that are allowed to be used for the current video unit, which are signalled in the bitstream for MIP.
   c. In one example, a pre-defined MIP mode list may be used.
      i. In one example, partial or all MIP modes of those are allowed to be used for the current video unit, which are signalled in the bitstream for MIP, may be used to construct the MIP mode list.
   d. In one example, the MIP mode list may be constructed adaptively.
      i. In one example, MIP modes from spatial (adjacent and/or non-adjacent) neighbouring video units may be used.
      ii. In one example, MIP modes from temporal neighbouring video units may be used.
         1) In one example, the temporal neighbouring video units may be from a different picture/slice.
      iii. In one example, a history MIP mode table/list may be constructed and MIP modes in the table/list may be used.
         1) In one example, the list/table may be updated during the coding/decoding process.
         2) In one example, the maximum size of the list/table may be pre-defined, or signalled, or derived.
         3) In one example, the list/table may be re-initialized at the beginning of a slice/tile/sub-picture/picture/CTU/CTU.
         a) In one example, the list/table may be re-initialized as a void list/table.
         b) In one example, the list/table may be re-initialized using one or more pre-defined/derived/signalled MIP mode.
         4) In one example, how to and/or whether to use/update the list/table may depend on coding information.
         a) In one example, the coding information may refer to block dimensions/size/position.
      iv. In one example, modified MIP modes may be used, which are generated using the MIP mode in the MIP mode list.
      v. In one example, default MIP modes may be used.
   e. In one example, whether to and/or how to construct the MIP mode list may depend on coding information.
      i. In one example, the coding information may refer to block size/dimensions.
3. In one example, MIP modes in a candidate list may be reordered.
   a. In one example, the MIP modes may be predefined MIP modes such as in VVC or ECM.
   b. In one example, the candidate list may be the constructed list.
   c. In one example, the MIP modes may be reordered according to template costs.
   d. In one example, a MIP mode with a smaller index after the reordering may be associated with a shorter codeword.
4. In one example, more than one MIP mode may be derived.
   a. In one example, the more than one MIP mode may be derived using the same template.
      i. In one example, the MIP modes with the first N minimum cost may be derived.
   b. In one example, the more than one MIP mode may be derived using different templates.
      i. In one example, the MIP modes may be derived using Template-L, and/or Template-A, and/or Template-L and Template-A.
5. In one example, one or more MIP modes may be fused to obtain the prediction/reconstruction of the current video unit.
   a. In one example, the MIP mode may refer to the signalled MIP mode or the derived MIP mode.
   b. In one example, more than one MIP modes may be fused.
      i. In one example, whether to and/or how to fuse the MIP modes may depend on coding information.
         1) In one example, the coding information may refer to the costs calculated in the derivation of the MIP mode.
   c. In one example, one or more MIP modes may be fused with a coding tool.
      i. In one example, the coding tool may refer to an intra coding tool.
         1) In one example,
      ii. In one example, the coding tool may refer to an inter coding tool.
         1) In one example,
      iii. In one example, the coding tool may refer to IBC/PLT/BDPCM.
   d. In one example, the weights used in fusion may be pre-defined, or signalled, or derived.
6. In one example, the DDMIP mode or MIP mode for the video units coded/decoded before coding/decoding the current video unit may be used for the current video unit.
   a. In one example, the video units coded/decoded before current video unit may be in a different slice/tile/sub-picture/picture/CTU/CTU row.
   b. In one example, the video units coded/decoded before current video unit may be in the same slice/tile/sub-picture/picture/CTU/CTU row as the current video unit.
   c. In one example, the video units coded/decoded before current video unit may be the neighbouring spatial (e.g., adjacent and/or non-adjacent) video units.
   d. In one example, the reused MIP mode may be stored in a list/table (e.g., a history MIP mode table).
      i. In one example, the list/table may be updated during the coding/decoding process.
      ii. In one example, the maximum size of the list/table may be pre-defined, or signalled, or derived.
      iii. In one example, the list/table may be re-initialized at the beginning of a slice/tile/sub-picture/picture/CTU/CTU.
         1) In one example, the list/table may be re-initialized as a void list/table.
         2) In one example, the list/table may be re-initialized using one or more pre-defined/derived/signalled MIP mode.
      iv. In one example, how to and/or whether to use/update the list/table may depend on coding information.
         1) In one example, the coding information may refer to block dimensions/size/position.
   e. In one example, when the current video unit is chroma video unit, the reused MIP mode may come from luma video unit and/or chroma video unit.
7. Whether to and/or how to apply DDMIP mode may depend on coding information, the coding information may refer to:
   a. whether a specific coding method is allowed, such as MIP
   b. block dimensions and/or block size
   c. block depth
   d. slice/picture type and/or partition tree type (single, or dual tree, or local dual tree)
   e. temporal layer identification
   f. block location
   g. CTU/slice/tile/sub-picture/picture resolution
   h. colour format
   i. colour component
      i. In one example, MIP and/or DDMIP may be applied to all colour components.
      ii. In one example, when MIP and/or DDMIP is applied to chroma components, it may be different from that for luma component.
      iii. In one example, whether to and/or how to apply MIP and/or DDMIP to a first component may depend on whether to and/or how to apply MIP and/or DDMIP merge mode to a second component.
         1) In one example, the first component may refer to chroma component (e.g., Cb and/or Cr), and the second component may refer to luma component (e.g., Y).
         2) In one example, the way to apply MIP and/or DDMIP to the first component may be same as the second component.
         a) Alternatively, the way to apply MIP and/or DDMIP to the first component may be different from the second component.
      iv. In one example, DDMIP may be applied to luma component, but not to chroma components
         1) In one example, luma component may refer to Y in YCbCr colour space or G in RGB colour space.
         2) In one example, chroma components may refer to Cb and/or Cr in YCbCr colour space or R and/or B in RGB colour space.
8. Indication of DDMIP may be conditionally signalled wherein the condition may include:
   a. block dimensions and/or block size
   b. block depth
   c. slice/picture type and/or partition tree type (single, or dual tree, or local dual tree)
   d. temporal layer identification
   e. block location
   f. CTU/slice/tile/sub-picture/picture resolution
   g. colour format
   h. colour component
9. Whether current block is coded with DDMIP may be signalled using one or more syntax elements (SE).
   a. In one example, the syntax element may be binarized with fixed length coding, or truncated unary coding, or unary coding, or EG coding, or coded a flag.
   b. In one example, the syntax element may be bypass coded or context coded.
      i. The context may depend on coded information, such as block dimensions, and/or block size, and/or slice/picture types, and/or the information of neighbouring blocks (adjacent or non-adjacent), and/or the information of other coding tools used for current block, and/or the information of temporal layer.
   c. In one example, the one or more syntax elements may be signalled at sequence header/picture header/SPS/VPS/DPS/DCI/PPS/APS/slice header/tile group header.
   d. In one example, the syntax element may be coded in a predictive way.
   e. In one example, the syntax element may be coded conditionally.
      i. For example, only if a first SE indicates that DDMIP is applicable, a second SE may be signaled to indicate whether DDMIP is used.
         1) The first SE may be at sequence header/picture header/SPS/VPS/DPS/DCI/PPS/APS/slice header/tile group header.
         2) The second SE may be for a block.
      ii. For example, only if the second SE indicates DDMIP is used, a third SE may be signaled to indicate how to perform DDMIP.
         1) In one example, the third SE may be used to indicate which derived DDMIP is used.
10. It is proposed that a filtering process may be used to refine the prediction/reconstruction of a video unit, where prediction/reconstruction is obtained using MIP or its variants (e.g., DDMIP).
   a. In one example, the filtering process may refer to deblocking filter, and/or SAO, and/or CCSAO, and/or BIF, and/or chroma BIF, and/or ALF, and/or chroma ALF, and/or CC-ALF.
   b. In one example, the filtering process may be a filtering process that used in intra prediction.
      i. In one example, the filtering process may refer to PDPC.
         1) In one example, an intra prediction mode may be derived and used in PDPC.
         a) In one example, the derived intra prediction mode may be used to get the parameters for PDPC.
         b) In one example, the intra prediction mode may be derived using DIMD.
         c) In one example, the intra prediction mode may be derived using TIMD.
         d) In one example, partial or all samples of the prediction/reconstruction may be used to derive the intra prediction mode.
         2) In one example, the way to apply PDPC for the video unit may be same as PDPC is applied to intra prediction.
         a) Alternatively, the way to apply PDPC for the video unit may be different from PDPC is applied to intra prediction.
         i. In one example, the n-th reference line may be used in PDPC instead of the 0-th reference line used in intra prediction, such as n is an integer larger than 0.

### General Aspects

11. In above examples, the video unit may refer to the video unit may refer to colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
12. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
13. Whether and/or how to apply the above methods may depend on the following information:
   a. A message signalled in the DPS/SPS/VPS/PPS/APS/picture header/slice header/tile group header/coding tree unit (CTU)/Coding unit (CU)/CTU row/group of CTUs/TU/PU block/Video coding unit
   b. Position of CU/PU/TU/block/Video coding unit
   c. Block dimension of current block and/or its neighbouring blocks
   d. Block shape of current block and/or its neighbouring blocks
   e. coded mode of a block, e.g., IBC or non-IBC inter mode or non-IBC subblock mode
   f. Indication of the colour format (such as 4:2:0, 4:4:4)
   g. Coding tree structure
   h. Slice/tile group type and/or picture type
   i. Colour component (e.g., may be only applied on chroma components or luma component)
   j. Temporal layer ID
   k. Profiles/Levels/Tiers of a standard.

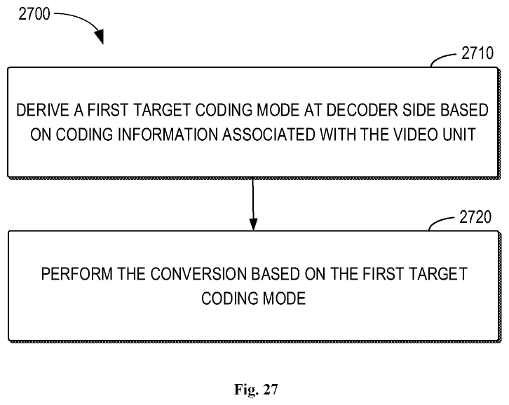

FIG. 27 illustrates a flowchart of a method 2700 for video processing in accordance with embodiments of the present disclosure. The method 2700 is implemented during a conversion between a video unit of a video and a bitstream of the video.

At block 2710, for a conversion between a video unit of a video and a bitstream of the video, a first target coding mode is derived at decoder side based on coding information associated with the video unit. In this case, the first target coding mode is a variant of a matrix weighted intra prediction (MIP) mode. For example, the first target coding mode is a decoder derived MIP (DDMIP).

At block 2720, the conversion is performed based on the first target coding mode. In some embodiments, the conversion may include encoding the video unit into the bitstream. Alternatively, the conversion may include decoding the video unit from the bitstream.

The method 2700 enables the first target coding mode to be derived, that is, the decoder derived MIP mode. Compared with the conventional solution, the method 2700 advantageously improves the coding efficiency and performance.

In some embodiments, the coding information may include at least one of: a coding mode or a reconstructed sample. In some embodiments, the first target coding mode may be derived without signaling. In some other embodiments, a flag may be signaled to indicate whether the first target coding mode is signaled or derived without signaling. In some embodiments, the first target coding mode may be derived based on at least one neighbouring sample of a current video unit. In addition, the first target coding mode may be used to obtain at least one of: a prediction of the current video unit, or a reconstruction of the current video unit.

In some embodiments, a template including at least one neighbouring sample of a current video unit may be used to derive the first target coding mode. In some embodiments, the at least one neighbouring sample may include at least one of: a neighbouring reconstructed sample, or a neighbouring predicted sample. In some other embodiments, the at least one neighbouring sample may include at least one of: an adjacent neighbouring sample, or a non-adjacent neighbouring sample.

In some embodiments, as shown in FIG. 25H, the template may include at least one of: a left template, an above template, a right above template, a left bottom template or a left above template. In this case, the left template may include at least one left neighbouring sample, the above template may include at least one above neighbouring sample, the right above template may include at least one right above neighbouring sample, the left bottom template may include at least one left bottom neighbouring sample, and the left above template may include at least one left above neighbouring sample. For example, the template may be non-adjacent to the current video unit, as shown in FIG. 25I.

In some embodiments, one of the following templates shown in FIG. 25H may be used to derive the first target coding mode: a left template, an above template, a right above template, a left bottom template or a left above template. In some embodiments, the left template may be used to derive the first target coding mode, as shown in FIG. 25D. In some other embodiments, the above template may be used to derive the first target coding mode, as shown in FIG. 25C.

In some embodiments, a plurality of templates may be used to derive the first target coding mode. In some embodiments, a left template and an above template may be used to derive the first target coding mode, as shown in FIG. 25B. In some embodiments, a left template, an above template (shown in FIG. 25B) and a left above template (shown in FIG. 25A) may be used to derive the first target coding mode. In some other embodiments, a left template and a left bottom template may be used to derive the first target coding mode, as shown in FIG. 25E. In some embodiments, an above template and a right above template may be used to derive the first target coding mode, as shown in FIG. 25F. Alternatively, a left template, a left bottom template, an above template and a right above template may be used to derive the first target coding mode, as shown in FIG. 25G. In some embodiments, a left template, a left bottom template, an above template, a right above template and a left above template may be used to derive the first target coding mode, as shown in FIG. 25H.

In some embodiments, a dimension of the template used to derive the first target coding mode may depend on coding information of the current video unit. In some other embodiments, a shape of the template used to derive the first target coding mode may depend on the coding information of the current video unit. Alternatively, a size of the template used to derive the first target coding mode may depend on the coding information of the current video unit. For example, the coding information of the current video unit may include at least one of: a block dimension, a block shape, a slice type, or a picture type. In some other embodiments, a dimension of the template used to derive the first target coding mode may be a constant value. For example, the constant value may include one of: 1, 2, 3, 4, 5, 6, 7, or 8. In some other embodiments, a size of the template used to derive the first target coding mode may be a constant value. For example, the constant value may include one of: 1, 2, 3, 4, 5, 6, 7, or 8.

In some embodiments, a MIP mode may be used to generate a prediction of a template, and a cost of the MIP mode may be calculated using the prediction of the template and a reconstruction of the template. In addition, a MIP mode in an MIP mode list with a minimum cost may be selected as the first target coding mode.

In some embodiments, a sum of absolute transformed difference (SATD) between the prediction of the template and the reconstruction of the template may be calculated and set as the cost of the MIP mode. In some other embodiments, a sum of squared error (SSE) between the prediction of the template and the reconstruction of the template may be calculated and set as the cost of the MIP mode. Alternatively, a sum of absolute difference (SAD) between the prediction of the template and the reconstruction of the template may be calculated and set as the cost of the MIP mode. In some embodiments, a subjective quality metric may be calculated and set as the cost of the MIP mode. In some embodiments, a structural similarity index measure (SSIM) may be calculated and set as the cost of the MIP mode. In some other embodiments, the cost of the MIP mode may be calculated as: D+lambda×R. In this case, D represents a metric of distortion such as SAD, SATD, or SSE, R represents the number of bits under consideration, and lambda represents a predetermined factor.

In some embodiments, at least one neighbouring sample of the template may be used to obtain the prediction of the template, for example, as shown in FIG. 26, which illustrates the derivation of the prediction of the template for the first target coding mode (i.e., decoder derived MIP). In some embodiments, a way to obtain the prediction of the template may be same as a way to obtain a prediction of a current video unit. Alternatively, a way to obtain the prediction of the template may be different from a way to obtain a prediction of a current video unit. In some embodiments, an averaging process for obtaining the prediction of the template may be different from an averaging process for obtaining the prediction of the current video unit. In some other embodiments, a linear interpolation for obtaining the prediction of the template may be different from a linear interpolation for obtaining the prediction of the current video unit.

In some embodiments, at least one line of the at least one neighbouring sample of the template may be used to obtain the prediction of the template. In some other embodiments, the at least one neighbouring sample of the template may be filtered before the at least one neighbouring sample of the template is used to obtain the prediction of the template. In some embodiments, a way to use the first target coding mode to obtain a prediction for a current video unit may be same as a way to use the MIP mode to obtain a prediction for a current video unit.

In some embodiments, a MIP mode list may be constructed and used in deriving the MIP mode. In some embodiments, the number of at least one MIP mode in the MIP mode list may be less than or equal to the number of MIP modes allowed to be used for a current video unit. In addition, the MIP modes allowed to be used may be signalled in a bitstream for MIP. Alternatively, the number of at least one MIP mode in the MIP mode list may be larger than the number of MIP modes allowed to be used for a current video unit.

In some embodiments, a MIP mode in the MIP mode list is one of MIP modes allowed to be used for a current video unit. In addition, the MIP mode in the MIP mode list may be signalled in a bitstream for MIP. Alternatively, at least one MIP mode in the MIP mode list may be different from any of MIP modes allowed to be used for a current video unit. In addition, the MIP modes allowed to be used may be signalled in a bitstream for MIP. In some embodiments, a predetermined MIP mode list may be used in deriving the MIP mode. For example, at least part of MIP modes that are allowed to be used for a current video unit may be used to construct the predetermined MIP mode list. In addition, the at least part of MIP modes may be signalled in a bitstream for MIP.

In some embodiments, the MIP mode list may be constructed in an adaptive manner. In some embodiments, a MIP mode from a spatial neighbouring video unit may be used to construct the MIP mode list. In this case, the spatial neighbouring video unit may include at least one of: an adjacent neighbouring video unit or a non-adjacent neighbouring video unit. In some other embodiments, a MIP mode from a temporal neighbouring video unit may be used to construct the MIP mode list. For example, the temporal neighbouring video unit may be from a different picture or a different slice.

In some embodiments, at least one of a history MIP mode table or a history MIP mode list may be constructed and at least one MIP mode in the at least one of the history MIP mode table or the history MIP mode list may be used to construct the MIP mode list. In some embodiments, the at least one of the history MIP mode table or the history MIP mode list may be updated during a coding process. In some embodiments, a maximum size of the at least one of the history MIP mode table or the history MIP mode list may be predetermined. In some other embodiments, the maximum size of the at least one of the history MIP mode table or the history MIP mode list may be signalled. Alternatively, the maximum size of the at least one of the history MIP mode table or the history MIP mode list may be derived. In some embodiments, the at least one of the history MIP mode table or the history MIP mode list may be re-initialized at beginning of at least one of: a slice, a tile, a sub-picture, a picture, or a coding tree unit (CTU). For example, the at least one of the history MIP mode table or the history MIP mode list may be re-initialized as a void list or a void table. Alternatively, the at least one of the history MIP mode table or the history MIP mode list may be re-initialized using at least one of: a predetermined MIP mode, a derived MIP mode, or a signalled MIP mode. In some embodiments, how to and/or whether to use and/or update the at least one of the history MIP mode table or the history MIP mode list may depend on coding information. For example, the coding information may include at least one of: a block dimension, a block size, or a block position.

In some embodiments, a modified MIP mode generated by using a MIP mode in the MIP mode list may be used to construct the MIP mode list. In some other embodiments, a default MIP mode may be used to construct the MIP mode list. In some embodiments, whether to and/or how to construct the MIP mode list may depend on coding information. For example, the coding information may include at least one of a block dimension or a block size.

In some embodiments, a plurality of MIP modes may be derived. In some embodiments, the plurality of MIP modes may be derived using a same template. For example, at least one MIP mode with a first predetermined number of minimum cost may be derived. In some other embodiments, the plurality of MIP modes may be derived using different templates. For example, the plurality of MIP modes may be derived using at least one of: a left template or an above template.

In some embodiments, at least one MIP mode may be fused to obtain at least one of: a prediction of a current video unit, or a reconstruction of the current video unit. In some embodiments, the at least one MIP mode may include at least one of: a signalled MIP mode or a derived MIP mode. In some other embodiments, a plurality of MIP modes may be fused. In some examples, whether to and/or how to fuse the plurality of MIP modes may depend on coding information. For example, the coding information may include a cost calculated in deriving the MIP mode. In some embodiments, the at least one MIP mode may be fused with a coding tool. In some examples, the coding tool may include an intra coding tool. In some other examples, the coding tool may include an inter coding tool. Alternatively, the coding tool may include at least one of: an intra block copy (IBC), PLT, or a block differential pulse coded modulation (BDPCM). In some embodiments, at least one weight used in the fusion may be predetermined. In some other embodiments, the at least one weight used in the fusion may be signalled. In some embodiments, the at least one weight used in the fusion may be derived.

In some embodiments, at least one of the first target coding mode or the MIP mode may be used for a current video unit. In this case, the at least one of the first target coding mode or the MIP mode is used for a video unit coded before coding the current video unit. In some embodiments, if the current video unit is a chroma video unit, the at least one of the first target coding mode or the MIP mode reused may be from at least one of: a luma video unit, or a chroma video unit. In some embodiments, the video unit coded before the current video unit may be in one of: a different slice, a different tile, a different sub-picture, a different picture, a different CTU, or a different CTU row. In some other embodiments, the video unit coded before the current video unit may be in one of: a same slice as the current video unit, a same tile as the current video unit, a same sub-picture as the current video unit, a same picture as the current video unit, a same CTU as the current video unit, or a same CTU row as the current video unit. In some embodiments, the video unit coded before the current video unit may be a neighbouring spatial video unit. For example, the neighbouring spatial video unit may include at least one of: an adjacent neighbouring video unit, or a non-adjacent neighbouring video unit.

In some embodiments, the at least one of the first target coding mode or the MIP mode reused may be stored in at least one of a list or a table. For example, the at least one of the list or the table may include a history MIP mode table. In some embodiments, the at least one of the list or the table may be updated during a coding process. In some embodiments, a maximum size of the at least one of the list or the table may be predetermined. In some other embodiments, the maximum size of the at least one of the list or the table may be signalled. Alternatively, the maximum size of the at least one of the list or the table may be derived. In some embodiments, the at least one of the list or the table may be re-initialized at beginning of at least one of: a slice, a tile, a sub-picture, a picture, or a coding tree unit (CTU). For example, the at least one of the list or the table may be re-initialized as a void list or a void table. Alternatively, the at least one of the list or the table may be re-initialized using at least one of: a predetermined MIP mode, a derived MIP mode, or a signalled MIP mode. In some embodiments, how to and/or whether to use and/or update the at least one of the list or the table may depend on coding information. For example, the coding information may include at least one of: a block dimension, a block size, or a block position.

In some embodiments, a filtering process may be used to refine at least one of a prediction of the video unit or a reconstruction of the video unit obtained by using at least one of the MIP mode or a variant of the MIP mode. For example, the variant of the MIP mode may include the first target coding mode, that is, a decoder derived MIP. In some embodiments, the filtering process may include at least one of: a deblocking filter, a sample adaptive offset (SAO), a cross-component sample adaptive offset (CCSAO), BIF, a chroma BIF, an adaptive loop filter (ALF), a chroma ALF, or a cross-component adaptive loop filter (CC-ALF).

In some embodiments, the filtering process may include a filtering process used in an intra prediction. In some embodiments, the filtering process may include a position dependent intra prediction combination (PDPC). In some embodiments, an intra prediction mode may be derived and used in the PDPC. In some embodiments, the derived intra prediction mode may be used to obtain a parameter for the PDPC. In some other embodiments, the intra prediction mode may be derived by using a decoder side intra mode derivation (DIMD). Alternatively, the intra prediction mode may be derived by using a template-based intra mode derivation (TIMD). In some embodiments, at least part of the at least one of the prediction of the video unit or the reconstruction of the video unit may be used to derive the intra prediction mode.

In some embodiments, a way to apply the PDPC for the video unit may be same as a way to apply the PDPC in an intra prediction. Alternatively, a way to apply the PDPC for the video unit may be different from a way to apply the PDPC in an intra prediction. For example, n-th reference line may be used in the PDPC and a zeroth reference line may be used in the intra prediction. In this case, the n is an integer larger than zero.

In some embodiments, at least one MIP mode in a candidate list may be reordered. In some embodiments, the at least one MIP mode may be predetermined, such as in VVC or ECM. In some other embodiments, the candidate list may be a constructed list. In some embodiments, the at least one MIP mode may be reordered based on at least one template cost. In some embodiments, a MIP mode with a smaller index after the reordering may be associated with a shorter codeword.

In some embodiments, whether to and/or how to apply the first target coding mode may depend on coding information. In this case, the coding information may include at least one of the followings: whether a coding approach is allowed, a block dimension, a block size, a block depth, a slice type, a picture type, a partition tree type, a temporal layer identification, a block location, a CTU resolution, a slice resolution, a tile resolution, a sub-picture resolution, a picture resolution, a colour format, or a colour component. In some embodiments, the coding approach may include MIP.

In some embodiments, at least one of: the MIP mode or the first target coding mode may be applied to the colour component. In some embodiments, if at least one of the MIP mode or the first target is applied to a chroma component, the at least one of the MIP mode or the first target applied to a chroma component may be different from applied to a luma component. In some embodiments, whether to and/or how to apply at least one of: the MIP mode or the first target coding mode to a first component may depend on whether to and/or how to apply at least one of: the MIP mode or the first target coding mode to a second component. In some examples, the first component may include a chroma component and the second component may include a luma component. For example, the chroma component may include Cb and/or Cr, and the luma component may includes Y. In some embodiments, a way to apply the at least one of: the MIP mode or the first target coding mode to the first component may be same as a way to apply the at least one of: the MIP mode or the first target coding mode to the second component. Alternatively, a way to apply the at least one of: the MIP mode or the first target coding mode to the first component may be different from a way to apply the at least one of: the MIP mode or the first target coding mode to the second component. In some embodiments, the first target coding mode may be applied to a luma component, and the first target coding mode may not be applied to a chroma component. For example, the luma component may include at least one of: Y in YCbCr colour space or G in RGB colour space. In addition, the chroma component may include at least one of: Cb in YCbCr colour space, Cr in YCbCr colour space, R in RGB colour space, or B in RGB colour space. In some embodiments, the partition tree type may include at least one of: a single tree, a dual tree, or a local dual tree.

In some embodiments, if a condition is satisfied, an indication of the first target coding mode may be signalled. For example, the condition may include at least one of the followings: a block dimension, a block size, a block depth, a slice type, a picture type, a partition tree type, a temporal layer identification, a block location, a CTU resolution, a slice resolution, a tile resolution, a sub-picture resolution, a picture resolution, a colour format, or a colour component. In some examples, the partition tree type may include at least one of: a single tree, a dual tree, or a local dual tree.

In some embodiments, whether a current block is coded with the first target coding mode may be signalled by using one or more syntax elements (SE). In some embodiments, the syntax element may be binarized with at least one of: fixed length coding, truncated unary coding, unary coding, EG coding, or coded a flag. In some other embodiments, the syntax element may be bypass coded. Alternatively, the syntax element may be context coded. For example, the context may depend on coded information, for example, the coded information may include at least one of the followings: a block dimension, a block size, a slice type, a picture type, information of a neighbouring block, information of another coding tool used for the current block, or information of a temporal layer. In some examples, the neighbouring block may include an adjacent neighbouring block and/or a non-adjacent neighbouring block.

In some embodiments, the one or more syntax elements may be signaled at one of the followings: a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header. In some embodiments, the one or more syntax elements may be coded in a predictive way. In some other embodiments, if a condition is satisfied, the one or more syntax elements may be coded. In some embodiments, if a first syntax element indicates that the first target coding mode is applicable, a second syntax element may be signaled to indicate whether the first target coding mode is used. For example, the first syntax element may be at one of the followings: a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header. In some embodiments, the second syntax element may be a syntax element for a block. In some embodiments, if a second syntax element indicates that the first target coding mode is used, a third syntax element may be signaled to indicate how to perform the first target coding mode. For example, the third syntax element may be used to indicate a derived first target coding mode to be used.

In some embodiments, the video unit may include at least one of the followings: a colour component, a sub-picture, a slice, a tile, a coding tree unit (CTU), a CTU row, a group of CTU, a coding unit (CU), a prediction unit (PU), a transform unit (TU), a coding tree block (CTB), a coding block (CB), a prediction block (PB), a transform block (TB), a block, a sub-block of a block, a sub-region within a block, a region containing more than one sample or pixel.

In some embodiments, an indication of whether to and/or how to derive the first target coding mode may be indicated at one of the followings: sequence level, group of pictures level, picture level, slice level, or tile group level. In some embodiments, an indication of whether to and/or how to derive the first target coding mode may be indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

In some embodiments, whether to and/or how to derive the first target coding mode may depend on at least one of the following information: a message signalled in one of: a DPS, a SPS, a VPS, a PPS, an APS, a picture header, a slice header, a tile group header, a coding tree unit (CTU), a coding unit (CU), a CTU row, a group of CTUs, a TU, a PU block, or a video coding unit, a position of a CU, a position of a PU, a position of a TU, a position of a block, a position of a video coding unit, a block dimension of a current block, a block dimension of a neighbouring block of the current block, a block shape of a current block, a block shape of a neighbouring block of the current block, a coded mode of a block, an indication of a colour format, a coding tree structure, a slice group type, a tile group type, a picture type, a colour component, a temporal layer identification, a profile of a standard, a level of a standard, or a tier of a standard. In some embodiments, the coded mode of the block may include at least one of: an IBC inter mode, a non-IBC inter mode, or a non-IBC subblock mode. In some other embodiments, the indication of the colour format may include 4:2:0 or 4:4:4. In some embodiments, the colour component may be applied on one of: a chroma component or a luma component.

According to further embodiments of the present disclosure, a non-transitory computer-readable recording medium is provided. The non-transitory computer-readable recording medium stores a bitstream of a video which is generated by a method performed by an apparatus for video processing. The method comprises: deriving a first target coding mode at decoder side based on coding information associated with a video unit of the video, wherein the first target coding mode is a variant of a matrix weighted intra prediction (MIP) mode; and generating the bitstream based on the first target coding mode.

According to still further embodiments of the present disclosure, a method for storing bitstream of a video is provided. The method comprises: deriving a first target coding mode at decoder side based on coding information associated with a video unit of the video, wherein the first target coding mode is a variant of a matrix weighted intra prediction (MIP) mode; generating the bitstream based on the first target coding mode; and storing the bitstream in a non-transitory computer-readable recording medium.

Implementations of the present disclosure can be described in view of the following clauses, the features of which can be combined in any reasonable manner.
Clause 1. A method for video processing, comprising: deriving, for a conversion between a video unit of a video and a bitstream of the video, a first target coding mode at decoder side based on coding information associated with the video unit, wherein the first target coding mode is a variant of a matrix weighted intra prediction (MIP) mode; and performing the conversion based on the first target coding mode.
Clause 2. The method of clause 1, wherein the coding information comprises at least one of: a coding mode or a reconstructed sample.
Clause 3. The method of clause 1, wherein the first target coding mode is derived without signaling.
Clause 4. The method of clause 1, wherein a flag is signaled to indicate whether the first target coding mode is signaled or derived without signaling.
Clause 5. The method of clause 1, wherein the first target coding mode is derived based on at least one neighbouring sample of a current video unit, wherein the first target coding mode is used to obtain at least one of: a prediction of the current video unit, or a reconstruction of the current video unit.
Clause 6. The method of clause 1, wherein a template comprising at least one neighbouring sample of a current video unit is used to derive the first target coding mode.
Clause 7. The method of clause 6, wherein the at least one neighbouring sample comprises at least one of: a neighbouring reconstructed sample, or a neighbouring predicted sample.
Clause 8. The method of clause 6, wherein the at least one neighbouring sample comprises at least one of: an adjacent neighbouring sample, or a non-adjacent neighbouring sample.
Clause 9. The method of clause 6, wherein the template comprises at least one of: a left template, an above template, a right above template, a left bottom template or a left above template, wherein the left template comprises at least one left neighbouring sample, the above template comprises at least one above neighbouring sample, the right above template comprises at least one right above neighbouring sample, the left bottom template comprises at least one left bottom neighbouring sample, and the left above template comprises at least one left above neighbouring sample.
Clause 10. The method of clause 9, wherein the template is non-adjacent to the current video unit.
Clause 11. The method of clause 6, wherein one of the following templates is used to derive the first target coding mode: a left template, an above template, a right above template, a left bottom template or a left above template.
Clause 12. The method of clause 11, wherein the left template is used to derive the first target coding mode.
Clause 13. The method of clause 11, wherein the above template is used to derive the first target coding mode.
Clause 14. The method of clause 6, wherein a plurality of templates are used to derive the first target coding mode.
Clause 15. The method of clause 14, wherein a left template and an above template are used to derive the first target coding mode.
Clause 16. The method of clause 14, wherein a left template, an above template and a left above template are used to derive the first target coding mode.
Clause 17. The method of clause 14, wherein a left template and a left bottom template are used to derive the first target coding mode.
Clause 18. The method of clause 14, wherein an above template and a right above template are used to derive the first target coding mode.
Clause 19. The method of clause 14, wherein a left template, a left bottom template, an above template and a right above template are used to derive the first target coding mode.
Clause 20. The method of clause 6, wherein a left template, a left bottom template, an above template, a right above template and a left above template are used to derive the first target coding mode.
Clause 21. The method of clause 6, wherein a dimension of the template used to derive the first target coding mode depends on coding information of the current video unit, or wherein a shape of the template used to derive the first target coding mode depends on the coding information of the current video unit, or wherein a size of the template used to derive the first target coding mode depends on the coding information of the current video unit.
Clause 22. The method of clause 21, wherein the coding information of the current video unit comprises at least one of: a block dimension, a block shape, a slice type, or a picture type.
Clause 23. The method of clause 6, wherein a dimension of the template used to derive the first target coding mode is a constant value, wherein the constant value comprises one of: 1, 2, 3, 4, 5, 6, 7, or 8.
Clause 24. The method of clause 6, wherein a size of the template used to derive the first target coding mode is a constant value, wherein the constant value comprises one of: 1, 2, 3, 4, 5, 6, 7, or 8.
Clause 25. The method of clause 1, wherein a MIP mode is used to generate a prediction of a template, and a cost of the MIP mode is calculated using the prediction of the template and a reconstruction of the template, wherein a MIP mode in an MIP mode list with a minimum cost is selected as the first target coding mode.
Clause 26. The method of clause 25, wherein a sum of absolute transformed difference (SATD) between the prediction of the template and the reconstruction of the template is calculated and set as the cost of the MIP mode.
Clause 27. The method of clause 25, wherein a sum of squared error (SSE) between the prediction of the template and the reconstruction of the template is calculated and set as the cost of the MIP mode.
Clause 28. The method of clause 25, wherein a sum of absolute difference (SAD) between the prediction of the template and the reconstruction of the template is calculated and set as the cost of the MIP mode.
Clause 29. The method of clause 25, wherein a subjective quality metric is calculated and set as the cost of the MIP mode.
Clause 30. The method of clause 25, wherein a structural similarity index measure (SSIM) is calculated and set as the cost of the MIP mode.
Clause 31. The method of clause 25, wherein the cost of the MIP mode is calculated as: D+lambda×R, wherein D represents a metric of distortion comprising at least one of SAD, SATD, or SSE, R represents the number of bits under consideration, and lambda represents a predetermined factor.
Clause 32. The method of clause 25, wherein at least one neighbouring sample of the template is used to obtain the prediction of the template.
Clause 33. The method of clause 32, wherein a way to obtain the prediction of the template is same as a way to obtain a prediction of a current video unit.
Clause 34. The method of clause 32, wherein a way to obtain the prediction of the template is different from a way to obtain a prediction of a current video unit.
Clause 35. The method of clause 34, wherein an averaging process for obtaining the prediction of the template is different from an averaging process for obtaining the prediction of the current video unit.
Clause 36. The method of clause 34, wherein a linear interpolation for obtaining the prediction of the template is different from a linear interpolation for obtaining the prediction of the current video unit.
Clause 37. The method of clause 32, wherein at least one line of the at least one neighbouring sample of the template is used to obtain the prediction of the template.
Clause 38. The method of clause 32, wherein the at least one neighbouring sample of the template is filtered before the at least one neighbouring sample of the template is used to obtain the prediction of the template.
Clause 39. The method of clause 1, wherein a way to use the first target coding mode to obtain a prediction for a current video unit is same as a way to use the MIP mode to obtain a prediction for a current video unit.
Clause 40. The method of clause 1, wherein a MIP mode list is constructed and used in deriving the MIP mode.
Clause 41. The method of clause 40, wherein the number of at least one MIP mode in the MIP mode list is less than or equal to the number of MIP modes allowed to be used for a current video unit, wherein the MIP modes allowed to be used are signalled in a bitstream for MIP.
Clause 42. The method of clause 40, wherein the number of at least one MIP mode in the MIP mode list is larger than the number of MIP modes allowed to be used for a current video unit.
Clause 43. The method of clause 40, wherein a MIP mode in the MIP mode list is one of MIP modes allowed to be used for a current video unit, wherein the MIP mode in the MIP mode list is signalled in a bitstream for MIP.
Clause 44. The method of clause 40, wherein at least one MIP mode in the MIP mode list is different from MIP modes allowed to be used for a current video unit, wherein the MIP modes allowed to be used are signalled in a bitstream for MIP.
Clause 45. The method of clause 40, wherein a predetermined MIP mode list is used in deriving the MIP mode.
Clause 46. The method of clause 45, wherein at least part of MIP modes that are allowed to be used for a current video unit are used to construct the predetermined MIP mode list, and the at least part of MIP modes are signalled in a bitstream for MIP.
Clause 47. The method of clause 40, wherein the MIP mode list is constructed in an adaptive manner.
Clause 48. The method of clause 47, wherein a MIP mode from a spatial neighbouring video unit is used to construct the MIP mode list, wherein the spatial neighbouring video unit comprises at least one of: an adjacent neighbouring video unit or a non-adjacent neighbouring video unit.
Clause 49. The method of clause 47, wherein a MIP mode from a temporal neighbouring video unit is used to construct the MIP mode list.
Clause 50. The method of clause 49, wherein the temporal neighbouring video unit is included in a different picture or a different slice.
Clause 51. The method of clause 47, wherein at least one of a history MIP mode table or a history MIP mode list is constructed and at least one MIP mode in the at least one of the history MIP mode table or the history MIP mode list is used to construct the MIP mode list.
Clause 52. The method of clause 51, wherein the at least one of the history MIP mode table or the history MIP mode list is updated during a coding process.
Clause 53. The method of clause 51, wherein a maximum size of the at least one of the history MIP mode table or the history MIP mode list is predetermined, or wherein the maximum size of the at least one of the history MIP mode table or the history MIP mode list is signalled, or wherein the maximum size of the at least one of the history MIP mode table or the history MIP mode list is derived.
Clause 54. The method of clause 51, wherein the at least one of the history MIP mode table or the history MIP mode list is re-initialized at beginning of at least one of: a slice, a tile, a sub-picture, a picture, or a coding tree unit (CTU).
Clause 55. The method of clause 54, wherein the at least one of the history MIP mode table or the history MIP mode list is re-initialized as a void list or a void table.
Clause 56. The method of clause 54, wherein the at least one of the history MIP mode table or the history MIP mode list is re-initialized using at least one of: a predetermined MIP mode, a derived MIP mode, or a signalled MIP mode.
Clause 57. The method of clause 51, wherein how to and/or whether to use and/or update the at least one of the history MIP mode table or the history MIP mode list depends on coding information.
Clause 58. The method of clause 57, wherein the coding information comprises at least one of: a block dimension, a block size, or a block position.
Clause 59. The method of clause 47, wherein a modified MIP mode generated by using a MIP mode in the MIP mode list is used to construct the MIP mode list.
Clause 60. The method of clause 47, wherein a default MIP mode is used to construct the MIP mode list.
Clause 61. The method of clause 40, wherein whether to and/or how to construct the MIP mode list depends on coding information.
Clause 62. The method of clause 61, wherein the coding information comprises at least one of a block dimension or a block size.
Clause 63. The method of clause 1, wherein a plurality of MIP modes are derived.
Clause 64. The method of clause 63, wherein the plurality of MIP modes are derived using a same template.
Clause 65. The method of clause 64, wherein at least one MIP mode with a first predetermined number of minimum cost is derived.
Clause 66. The method of clause 63, wherein the plurality of MIP modes are derived using different templates.
Clause 67. The method of clause 66, wherein the plurality of MIP modes are derived using at least one of: a left template or an above template.
Clause 68. The method of clause 1, wherein at least one MIP mode is fused to obtain at least one of: a prediction of a current video unit, or a reconstruction of the current video unit.
Clause 69. The method of clause 68, wherein the at least one MIP mode comprises at least one of: a signalled MIP mode or a derived MIP mode.
Clause 70. The method of clause 68, wherein a plurality of MIP modes are fused.
Clause 71. The method of clause 70, wherein whether to and/or how to fuse the plurality of MIP modes depends on coding information.
Clause 72. The method of clause 71, wherein the coding information comprises a cost calculated in deriving the MIP mode.
Clause 73. The method of clause 68, wherein the at least one MIP mode is fused with a coding tool.
Clause 74. The method of clause 73, wherein the coding tool comprises an intra coding tool.
Clause 75. The method of clause 73, wherein the coding tool comprises an inter coding tool.
Clause 76. The method of clause 73, wherein the coding tool comprises at least one of: an intra block copy (IBC), PLT, or a block differential pulse coded modulation (BDPCM).
Clause 77. The method of clause 68, wherein at least one weight used in the fusion is predetermined, or wherein the at least one weight used in the fusion is signalled, or wherein the at least one weight used in the fusion is derived.
Clause 78. The method of clause 1, wherein at least one of the first target coding mode or the MIP mode is used for a current video unit, wherein the at least one of the first target coding mode or the MIP mode is used for a video unit coded before coding the current video unit.
Clause 79. The method of clause 78, wherein if the current video unit is a chroma video unit, the at least one of the first target coding mode or the MIP mode reused is from at least one of: a luma video unit, or a chroma video unit.
Clause 80. The method of clause 78, wherein the video unit coded before the current video unit is in one of: a different slice, a different tile, a different sub-picture, a different picture, a different CTU, or a different CTU row.
Clause 81. The method of clause 78, wherein the video unit coded before the current video unit is in one of: a same slice as the current video unit, a same tile as the current video unit, a same sub-picture as the current video unit, a same picture as the current video unit, a same CTU as the current video unit, or a same CTU row as the current video unit.
Clause 82. The method of clause 78, wherein the video unit coded before the current video unit is a neighbouring spatial video unit, wherein the neighbouring spatial video unit comprises at least one of: an adjacent neighbouring video unit, or a non-adjacent neighbouring video unit.
Clause 83. The method of clause 78, wherein the at least one of the first target coding mode or the MIP mode reused is stored in at least one of a list or a table.
Clause 84. The method of clause 83, wherein the at least one of the list or the table comprises a history MIP mode table.
Clause 85. The method of clause 83, wherein the at least one of the list or the table is updated during a coding process.
Clause 86. The method of clause 83, wherein a maximum size of the at least one of the list or the table is predetermined, or wherein the maximum size of the at least one of the list or the table is signalled, or wherein the maximum size of the at least one of the list or the table is derived.
Clause 87. The method of clause 83, wherein the at least one of the list or the table is re-initialized at beginning of at least one of: a slice, a tile, a sub-picture, a picture, or a coding tree unit (CTU).
Clause 88. The method of clause 87, wherein the at least one of the list or the table is re-initialized as a void list or a void table.
Clause 89. The method of clause 87, wherein the at least one of the list or the table is re-initialized using at least one of: a predetermined MIP mode, a derived MIP mode, or a signalled MIP mode.
Clause 90. The method of clause 83, wherein how to and/or whether to use and/or update the at least one of the list or the table depends on coding information.
Clause 91. The method of clause 90, wherein the coding information comprises at least one of: a block dimension, a block size, or a block position.
Clause 92. The method of clause 1, wherein a filtering process is used to refine at least one of a prediction of the video unit or a reconstruction of the video unit obtained by using at least one of the MIP mode or a variant of the MIP mode.
Clause 93. The method of clause 92, wherein the variant of the MIP mode comprises the first target coding mode.
Clause 94. The method of clause 92, wherein the filtering process comprises at least one of: a deblocking filter, a sample adaptive offset (SAO), a cross-component sample adaptive offset (CCSAO), BIF, a chroma BIF, an adaptive loop filter (ALF), a chroma ALF, or a cross-component adaptive loop filter (CC-ALF).
Clause 95. The method of clause 92, wherein the filtering process comprises a filtering process used in an intra prediction.
Clause 96. The method of clause 95, wherein the filtering process comprises a position dependent intra prediction combination (PDPC).
Clause 97. The method of clause 96, wherein an intra prediction mode is derived and used in the PDPC.
Clause 98. The method of clause 97, wherein the derived intra prediction mode is used to obtain a parameter for the PDPC.
Clause 99. The method of clause 97, wherein the intra prediction mode is derived by using a decoder side intra mode derivation (DIMD).
Clause 100. The method of clause 97, wherein the intra prediction mode is derived by using a template-based intra mode derivation (TIMD).
Clause 101. The method of clause 97, wherein at least part of the at least one of the prediction of the video unit or the reconstruction of the video unit is used to derive the intra prediction mode.
Clause 102. The method of clause 96, wherein a way to apply the PDPC for the video unit is same as a way to apply the PDPC in an intra prediction.
Clause 103. The method of clause 96, wherein a way to apply the PDPC for the video unit is different from a way to apply the PDPC in an intra prediction.
Clause 104. The method of clause 103, wherein n-th reference line is used in the PDPC and a zeroth reference line is used in the intra prediction, wherein the n is an integer larger than zero.
Clause 105. The method of clause 1, wherein at least one MIP mode in a candidate list is reordered.
Clause 106. The method of clause 105, wherein the at least one MIP mode is predetermined.
Clause 107. The method of clause 105, wherein the candidate list is a constructed list.
Clause 108. The method of clause 105, wherein the at least one MIP mode is reordered based on at least one template cost.
Clause 109. The method of clause 105, wherein a MIP mode with a smaller index after the reordering is associated with a shorter codeword.
Clause 110. The method of clause 1, wherein whether to and/or how to apply the first target coding mode depends on coding information, wherein the coding information comprises at least one of the followings: whether a coding approach is allowed, a block dimension, a block size, a block depth, a slice type, a picture type, a partition tree type, a temporal layer identification, a block location, a CTU resolution, a slice resolution, a tile resolution, a sub-picture resolution, a picture resolution, a colour format, or a colour component.
Clause 111. The method of clause 110, wherein the coding approach comprises MIP.
Clause 112. The method of clause 110, wherein at least one of: the MIP mode or the first target coding mode is applied to the colour component.
Clause 113. The method of clause 110, wherein if at least one of the MIP mode or the first target is applied to a chroma component, the at least one of the MIP mode or the first target applied to a chroma component is different from applied to a luma component.
Clause 114. The method of clause 110, wherein whether to and/or how to apply at least one of: the MIP mode or the first target coding mode to a first component depends on whether to and/or how to apply at least one of: the MIP mode or the first target coding mode to a second component.
Clause 115. The method of clause 114, wherein the first component comprises a chroma component and the second component comprises a luma component, wherein the chroma component comprises Cb and/or Cr, and the luma component comprises Y.
Clause 116. The method of clause 114, wherein a way to apply the at least one of: the MIP mode or the first target coding mode to the first component is same as a way to apply the at least one of: the MIP mode or the first target coding mode to the second component.
Clause 117. The method of clause 114, wherein a way to apply the at least one of: the MIP mode or the first target coding mode to the first component is different from a way to apply the at least one of: the MIP mode or the first target coding mode to the second component.
Clause 118. The method of clause 110, wherein the first target coding mode is applied to a luma component, and the first target coding mode is not applied to a chroma component.
Clause 119. The method of clause 118, wherein the luma component comprises at least one of: Y in YCbCr colour space or Gin RGB colour space.
Clause 120. The method of clause 118, wherein the chroma component comprises at least one of: Cb in YCbCr colour space, Cr in YCbCr colour space, R in RGB colour space, or B in RGB colour space.
Clause 121. The method of clause 110, wherein the partition tree type comprises at least one of: a single tree, a dual tree, or a local dual tree.
Clause 122. The method of clause 1, wherein if a condition is satisfied, an indication of the first target coding mode is signalled, wherein the condition comprises at least one of the followings: a block dimension, a block size, a block depth, a slice type, a picture type, a partition tree type, a temporal layer identification, a block location, a CTU resolution, a slice resolution, a tile resolution, a sub-picture resolution, a picture resolution, a colour format, or a colour component.
Clause 123. The method of clause 122, wherein the partition tree type comprises at least one of: a single tree, a dual tree, or a local dual tree.
Clause 124. The method of clause 1, wherein whether a current block is coded with the first target coding mode is signalled by using one or more syntax elements (SE).
Clause 125. The method of clause 124, wherein the syntax element is binarized with at least one of: fixed length coding, truncated unary coding, unary coding, EG coding, or coded a flag.
Clause 126. The method of clause 124, wherein the syntax element is bypass coded, or wherein the syntax element is context coded.
Clause 127. The method of clause 126, wherein the context depends on coded information, wherein the coded information comprises at least one of the followings: a block dimension, a block size, a slice type, a picture type, information of a neighbouring block, information of another coding tool used for the current block, or information of a temporal layer.
Clause 128. The method of clause 127, wherein the neighbouring block comprises an adjacent neighbouring block and/or a non-adjacent neighbouring block.
Clause 129. The method of clause 124, wherein the one or more syntax elements are signaled at one of the followings: a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header.
Clause 130. The method of clause 124, wherein the one or more syntax elements are coded in a predictive way.
Clause 131. The method of clause 124, wherein if a condition is satisfied, the one or more syntax elements are coded.
Clause 132. The method of clause 131, wherein if a first syntax element indicates that the first target coding mode is applicable, a second syntax element is signaled to indicate whether the first target coding mode is used.
Clause 133. The method of clause 132, wherein the first syntax element is at one of the followings: a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header.
Clause 134. The method of clause 132, wherein the second syntax element is a syntax element for a block.
Clause 135. The method of clause 131, wherein if a second syntax element indicates that the first target coding mode is used, a third syntax element is signaled to indicate how to perform the first target coding mode.
Clause 136. The method of clause 133, wherein the third syntax element is used to indicate a derived first target coding mode to be used.
Clause 137. The method of any of clauses 1-136, wherein the video unit comprises at least one of the followings: a colour component, a sub-picture, a slice, a tile, a coding tree unit (CTU), a CTU row, a group of CTU, a coding unit (CU), a prediction unit (PU), a transform unit (TU), a coding tree block (CTB), a coding block (CB), a prediction block (PB), a transform block (TB), a block, a sub-block of a block, a sub-region within a block, a region containing more than one sample or pixel.
Clause 138. The method of any of clauses 1-136, wherein an indication of whether to and/or how to derive the first target coding mode is indicated at one of the followings: sequence level, group of pictures level, picture level, slice level, or tile group level.
Clause 139. The method of any of clauses 1-136, wherein an indication of whether to and/or how to derive the first target coding mode is indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.
Clause 140. The method of any of clauses 1-136, wherein whether to and/or how to derive the first target coding mode depends on at least one of the following information: a message signalled in one of: a DPS, a SPS, a VPS, a PPS, an APS, a picture header, a slice header, a tile group header, a coding tree unit (CTU), a coding unit (CU), a CTU row, a group of CTUs, a TU, a PU block, or a video coding unit, a position of a CU, a position of a PU, a position of a TU, a position of a block, a position of a video coding unit, a block dimension of a current block, a block dimension of a neighbouring block of the current block, a block shape of a current block, a block shape of a neighbouring block of the current block, a coded mode of a block, an indication of a colour format, a coding tree structure, a slice group type, a tile group type, a picture type, a colour component, a temporal layer identification, a profile of a standard, a level of a standard, or a tier of a standard.
Clause 141. The method of clause 140, wherein the coded mode of the block comprises at least one of: an IBC inter mode, a non-IBC inter mode, or a non-IBC subblock mode.
Clause 142. The method of clause 140, wherein the indication of the colour format comprises 4:2:0 or 4:4:4.
Clause 143. The method of clause 140, wherein the colour component is applied on one of: a chroma component or a luma component.
Clause 144. The method of any of clauses 1-143, wherein the conversion includes encoding the video unit into the bitstream.
Clause 145. The method of any of clauses 1-143, wherein the conversion includes decoding the video unit from the bitstream.
Clause 146. An apparatus for video processing comprising a processor and a non-transitory memory with instructions thereon, wherein the instructions upon execution by the processor, cause the processor to perform a method in accordance with any of clauses 1-145.
Clause 147. A non-transitory computer-readable storage medium storing instructions that cause a processor to perform a method in accordance with any of clauses 1-145.
Clause 148. A non-transitory computer-readable recording medium storing a bitstream of a video which is generated by a method performed by an apparatus for video processing, wherein the method comprises: deriving a first target coding mode at decoder side based on coding information associated with a video unit of the video, wherein the first target coding mode is a variant of a matrix weighted intra prediction (MIP) mode; and generating the bitstream based on the first target coding mode.
Clause 149. A method for storing a bitstream of a video, comprising: deriving a first target coding mode at decoder side based on coding information associated with a video unit of the video, wherein the first target coding mode is a variant of a matrix weighted intra prediction (MIP) mode; generating the bitstream based on the first target coding mode; and storing the bitstream in a non-transitory computer-readable recording medium.

### Example Device

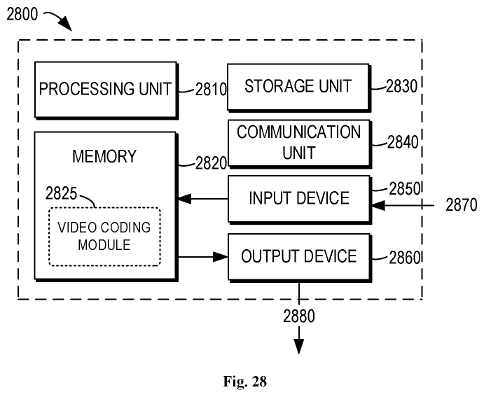

FIG. 28 illustrates a block diagram of a computing device 2800 in which various embodiments of the present disclosure can be implemented. The computing device 2800 may be implemented as or included in the source device 110 (or the video encoder 114 or 200) or the destination device 120 (or the video decoder 124 or 300).

It would be appreciated that the computing device 2800 shown in FIG. 28 is merely for purpose of illustration, without suggesting any limitation to the functions and scopes of the embodiments of the present disclosure in any manner.

As shown in FIG. 28, the computing device 2800 includes a general-purpose computing device 2800. The computing device 2800 may at least comprise one or more processors or processing units 2810, a memory 2820, a storage unit 2830, one or more communication units 2840, one or more input devices 2850, and one or more output devices 2860.

In some embodiments, the computing device 2800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2800 can support any type of interface to a user (such as “wearable” circuitry and the like).

The processing unit 2810 may be a physical or virtual processor and can implement various processes based on programs stored in the memory 2820. In a multi-processor system, multiple processing units execute computer executable instructions in parallel so as to improve the parallel processing capability of the computing device 2800. The processing unit 2810 may also be referred to as a central processing unit (CPU), a microprocessor, a controller or a microcontroller.

The computing device 2800 typically includes various computer storage medium. Such medium can be any medium accessible by the computing device 2800, including, but not limited to, volatile and non-volatile medium, or detachable and non-detachable medium. The memory 2820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2830 may be any detachable or non-detachable medium and may include a machine-readable medium such as a memory, flash memory drive, magnetic disk or another other media, which can be used for storing information and/or data and can be accessed in the computing device 2800.

The computing device 2800 may further include additional detachable/non-detachable, volatile/non-volatile memory medium. Although not shown in FIG. 28, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2840 communicates with a further computing device via the communication medium. In addition, the functions of the components in the computing device 2800 can be implemented by a single computing cluster or multiple computing machines that can communicate via communication connections. Therefore, the computing device 2800 can operate in a networked environment using a logical connection with one or more other servers, networked personal computers (PCs) or further general network nodes.

The input device 2850 may be one or more of a variety of input devices, such as a mouse, keyboard, tracking ball, voice-input device, and the like. The output device 2860 may be one or more of a variety of output devices, such as a display, loudspeaker, printer, and the like. By means of the communication unit 2840, the computing device 2800 can further communicate with one or more external devices (not shown) such as the storage devices and display device, with one or more devices enabling the user to interact with the computing device 2800, or any devices (such as a network card, a modem and the like) enabling the computing device 2800 to communicate with one or more other computing devices, if required. Such communication can be performed via input/output (I/O) interfaces (not shown).

In some embodiments, instead of being integrated in a single device, some or all components of the computing device 2800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2800 may be used to implement video encoding/decoding in embodiments of the present disclosure. The memory 2820 may include one or more video coding modules 2825 having one or more program instructions. These modules are accessible and executable by the processing unit 2810 to perform the functionalities of the various embodiments described herein.

In the example embodiments of performing video encoding, the input device 2850 may receive video data as an input 2870 to be encoded. The video data may be processed, for example, by the video coding module 2825, to generate an encoded bitstream. The encoded bitstream may be provided via the output device 2860 as an output 2880.

In the example embodiments of performing video decoding, the input device 2850 may receive an encoded bitstream as the input 2870. The encoded bitstream may be processed, for example, by the video coding module 2825, to generate decoded video data. The decoded video data may be provided via the output device 2860 as the output 2880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for video processing, comprising:
deriving, for a conversion between a video unit of a video and a bitstream of the video, a first target coding mode at decoder side based on coding information associated with the video unit, wherein the first target coding mode is a variant of a matrix weighted intra prediction (MIP) mode; and
performing the conversion based on the first target coding mode.

2. The method of claim 1, wherein the coding information comprises at least one of: a coding mode or a reconstructed sample, and/or
wherein the first target coding mode is derived without signaling, and/or
wherein a flag is signaled to indicate whether the first target coding mode is signaled or derived without signaling, and/or
wherein the first target coding mode is derived based on at least one neighbouring sample of a current video unit, wherein the first target coding mode is used to obtain at least one of: a prediction of the current video unit, or a reconstruction of the current video unit, and/or
wherein a template comprising at least one neighbouring sample of a current video unit is used to derive the first target coding mode, and/or
wherein a MIP mode is used to generate a prediction of a template, and a cost of the MIP mode is calculated using the prediction of the template and a reconstruction of the template, wherein a MIP mode in an MIP mode list with a minimum cost is selected as the first target coding mode, and/or
wherein a way to use the first target coding mode to obtain a prediction for a current video unit is same as a way to use the MIP mode to obtain a prediction for a current video unit.

3. The method of claim 2, wherein the at least one neighbouring sample comprises at least one of: a neighbouring reconstructed sample, or a neighbouring predicted sample, and/or
wherein the at least one neighbouring sample comprises at least one of: an adjacent neighbouring sample, or a non-adjacent neighbouring sample, and/or
wherein the template comprises at least one of: a left template, an above template, a right above template, a left bottom template or a left above template, wherein the left template comprises at least one left neighbouring sample, the above template comprises at least one above neighbouring sample, the right above template comprises at least one right above neighbouring sample, the left bottom template comprises at least one left bottom neighbouring sample, and the left above template comprises at least one left above neighbouring sample, and/or
wherein a plurality of templates are used to derive the first target coding mode, and/or
wherein a left template, a left bottom template, an above template, a right above template and a left above template are used to derive the first target coding mode, and/or
wherein a dimension of the template used to derive the first target coding mode depends on coding information of the current video unit, or
wherein a shape of the template used to derive the first target coding mode depends on the coding information of the current video unit, or
wherein a size of the template used to derive the first target coding mode depends on the coding information of the current video unit, and/or
wherein a sum of absolute transformed difference (SATD) between the prediction of the template and the reconstruction of the template is calculated and set as the cost of the MIP mode, and/or
wherein at least one neighbouring sample of the template is used to obtain the prediction of the template.

4. The method of claim 1, wherein a MIP mode list is constructed and used in deriving the MIP mode.

5. The method of claim 4, wherein the number of at least one MIP mode in the MIP mode list is less than or equal to the number of MIP modes allowed to be used for a current video unit, wherein the MIP modes allowed to be used are signalled in a bitstream for MIP, and/or
wherein a MIP mode in the MIP mode list is one of MIP modes allowed to be used for a current video unit, wherein the MIP mode in the MIP mode list is signalled in a bitstream for MIP, and/or
wherein a predetermined MIP mode list is used in deriving the MIP mode, and/or
wherein the MIP mode list is constructed in an adaptive manner, and/or
wherein whether to and/or how to construct the MIP mode list depends on coding information.

6. The method of claim 5, wherein the number of at least one MIP mode in the MIP mode list is larger than the number of MIP modes allowed to be used for a current video unit, and/or
wherein at least one MIP mode in the MIP mode list is different from MIP modes allowed to be used for a current video unit, wherein the MIP modes allowed to be used are signalled in a bitstream for MIP, and/or
wherein at least part of MIP modes that are allowed to be used for a current video unit are used to construct the predetermined MIP mode list, and the at least part of MIP modes are signalled in a bitstream for MIP, and/or
wherein a MIP mode from a spatial neighbouring video unit is used to construct the MIP mode list, wherein the spatial neighbouring video unit comprises at least one of: an adjacent neighbouring video unit or a non-adjacent neighbouring video unit, and/or
wherein a MIP mode from a temporal neighbouring video unit is used to construct the MIP mode list, and/or
wherein at least one of a history MIP mode table or a history MIP mode list is constructed and at least one MIP mode in the at least one of the history MIP mode table or the history MIP mode list is used to construct the MIP mode list, and/or
wherein a modified MIP mode generated by using a MIP mode in the MIP mode list is used to construct the MIP mode list, and/or
wherein a default MIP mode is used to construct the MIP mode list, and/or
wherein the coding information comprises at least one of a block dimension or a block size.

7. The method of claim 1, wherein a plurality of MIP modes are derived.

8. The method of claim 7, wherein the plurality of MIP modes are derived using a same template, and/or
wherein the plurality of MIP modes are derived using different templates.

9. The method of claim 8, wherein at least one MIP mode with a first predetermined number of minimum cost is derived, and/or
wherein the plurality of MIP modes are derived using at least one of: a left template or an above template.

10. The method of claim 1, wherein at least one MIP mode is fused to obtain at least one of: a prediction of a current video unit, or a reconstruction of the current video unit.

11. The method of claim 10, wherein the at least one MIP mode comprises at least one of: a signalled MIP mode or a derived MIP mode, and/or
wherein a plurality of MIP modes are fused, and/or
wherein the at least one MIP mode is fused with a coding tool, and/or
wherein at least one weight used in the fusion is predetermined, or
wherein the at least one weight used in the fusion is signalled, or
wherein the at least one weight used in the fusion is derived.

12. The method of claim 11, wherein whether to and/or how to fuse the plurality of MIP modes depends on coding information, and/or
wherein the coding tool comprises an intra coding tool, and/or
wherein the coding tool comprises an inter coding tool, and/or
wherein the coding tool comprises at least one of: an intra block copy (IBC), PLT, or a block differential pulse coded modulation (BDPCM).

13. The method of claim 1, wherein at least one of the first target coding mode or the MIP mode is used for a current video unit, wherein the at least one of the first target coding mode or the MIP mode is used for a video unit coded before coding the current video unit.

14. The method of claim 13, wherein if the current video unit is a chroma video unit, the at least one of the first target coding mode or the MIP mode reused is from at least one of: a luma video unit, or a chroma video unit, and/or
wherein the video unit coded before the current video unit is in one of: a different slice, a different tile, a different sub-picture, a different picture, a different CTU, or a different CTU row, and/or
wherein the video unit coded before the current video unit is in one of: a same slice as the current video unit, a same tile as the current video unit, a same sub-picture as the current video unit, a same picture as the current video unit, a same CTU as the current video unit, or a same CTU row as the current video unit, and/or
wherein the video unit coded before the current video unit is a neighbouring spatial video unit, wherein the neighbouring spatial video unit comprises at least one of: an adjacent neighbouring video unit, or a non-adjacent neighbouring video unit, and/or
wherein the at least one of the first target coding mode or the MIP mode reused is stored in at least one of a list or a table, and/or
wherein the at least one of the list or the table comprises a history MIP mode table.

15. The method of claim 1, wherein a filtering process is used to refine at least one of a prediction of the video unit or a reconstruction of the video unit obtained by using at least one of the MIP mode or a variant of the MIP mode.

16. The method of claim 15, wherein the variant of the MIP mode comprises the first target coding mode, and/or
wherein the filtering process comprises at least one of: a deblocking filter, a sample adaptive offset (SAO), a cross-component sample adaptive offset (CCSAO), BIF, a chroma BIF, an adaptive loop filter (ALF), a chroma ALF, or a cross-component adaptive loop filter (CC-ALF), and/or
wherein the filtering process comprises a filtering process used in an intra prediction.

17. The method of claim 1, wherein the conversion includes encoding the video unit into the bitstream, or
wherein the conversion includes decoding the video unit from the bitstream.

18. The method of claim 1, wherein the conversion comprises: generating the bitstream from the video unit, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to:
derive, for a conversion between a video unit of a video and a bitstream of the video, a first target coding mode at decoder side based on coding information associated with the video unit, wherein the first target coding mode is a variant of a matrix weighted intra prediction (MIP) mode; and
perform the conversion based on the first target coding mode.

20. A non-transitory computer-readable storage medium storing instructions that cause a processor to:
derive, for a conversion between a video unit of a video and a bitstream of the video, a first target coding mode at decoder side based on coding information associated with the video unit, wherein the first target coding mode is a variant of a matrix weighted intra prediction (MIP) mode; and
perform the conversion based on the first target coding mode.
